(19) United States
(12) Patent Application Publication
(10) Pub. No.: US 2004/0236805 A1
(43) Pub. Date: Nov. 25, 2004

(54) Method and system for creating meaningful summaries from interrelated sets of information units

(76) Inventor: Goren Gordon, Rishon LeZion (IL)

Correspondence Address: Faier & Faier, P.C., 566 W. Adams Street, #600, Chicago, IL, 60661, US

(21) Appl. No.: 10/445,213

(22) Filed: May 23, 2003

(51) Int. Cl. G06F 17/30

(52) U.S. Cl. 707/205

(57) ABSTRACT

A method and system for summarizing information units is disclosed. In order to facilitate the selection of the most significant aspects of a collection of logically inter-related information units having diverse formats, data records representing the information units are introduced into a computing environment. The records are partitioned in a pre-determined manner into a set of sub-units. The sub-units are assigned a complexity metrics according to the inherent complexity of the content therein. Next, the sub-units are structured, indexed, and sorted into groups according to the complexity metrics thereof. One or more groups of sub-units are selected for processing in order to establish one or more information summary units to be used for analysis, comparison, dynamic control, adaptive control, and display.

### BACKGROUND OF THE INVENTION

1. Field of the Invention

The present invention generally relates to a system and method for summarizing information units. More specifically, the present invention relates to the summarizing of a data record by selecting particular aspects of the data record.

2. DISCUSSION OF THE RELATED ART

Due to the abundance of information sources and to the enormous volume of data available as a consequence of the so-called Information Age, creating useful, meaningful summaries of data has become increasingly important. Summaries are needed for a variety of types of data besides natural language text. Such a need also exists in the art regarding recorded data such as videos, sound recordings of spoken voices and music, sparse data such as radio astronomy records, nature studies filmed or recorded over lengthy periods of time, and the like. In addition, in health-care and in fields such as cryptography, geology, and almost every field of engineering there exists a need in the art to summarize recorded results of multi-variable data. Generally, multi-variable data recordings produce very long and complex data. This complex and lengthy data needs to be examined assiduously to coordinate significant segments of data or significant events and occurrences during the recording of this multi-variable data.

Methods for preparing summaries usually require a prior knowledge of both the subject matter as well as the application of the summary method. If such a prior knowledge and application is known than it is substantially easier to develop a summarizing method for such application. This principle is demonstrated in the use of arithmetic and other computation techniques that work successfully, regardless of what techniques are applied to.

Generally, current computer-summarizing techniques are inadequate. As an example related to a known prior art program product Microsoft Word Software, the AutoSummarize feature of the product is explained in the accompanying documentation as follows:

“Automatically summarize a document

“You can use the AutoSummarize feature to automatically summarize the key points in a document. If you want to create a summary for others to read, use AutoSummarize to copy the key points and insert them into an executive summary or abstract. If you want to read a summary of an online document, you can display the document in AutoSummarize view. In this view, you can switch between displaying only the key points in a document and highlighting them in the document. As you read, you can also change the level of detail at any time.

“How does AutoSummarize determine what the key points are? AutoSummarize analyzes the document and assigns a score to each sentence. (For example, it gives a higher score to sentences that contain words used frequently in the document.) You then choose a percentage of the highest-scoring sentences to display in the summary.

“Keep in mind that AutoSummarize works best on well-structured documents for example, reports, articles, and scientific papers.

“Note—For the best quality summaries, make sure that the Find All Word Forms tool is installed. For more information about installing this tool, click “What do you want to do?” Automatically create an executive summary or abstract. View an online document at different levels of detail.”

Microsoft Word documentation further explains: “Word has examined the document and picked the sentences most relevant to the main theme”.

Microsoft Word documentation also provides various alternatives for the summary such as “Highlight key points: insert an executive summary or abstract at the top of the document; Create a new document and put the summary there; and Hide everything but the summary without leaving the original document.” There is also a provision for selecting the summary length in terms of percentage of the original document.”

Microsoft AutoSummarize examines the document and picks out sentences that are most relevant to the theme of the document, whereas embodiments of the present invention will point to more interesting sentences. What Microsoft really means by “relevant” is the sentences that contain highest frequency occurring words in the document. In fact such sentences describe the background domain of knowledge, which would categorize the subject of the text and not the statement that the author wants to make about that subject.

In the recording of tapped telephone conversations, for example, long and largely irrelevant data is produced. Presently, the known method of monitoring involves the setting special filters for selecting particular words or phrases. These specific words must have special significance in the context of the circumstances. Where performing monitoring procedure by the setting of special filters, some important aspects of the information such as relative speaking times of the parties, volume, voice inflections, and the like are not determinable.

There is therefore a need in the art for an enhanced method for creating summaries where the knowledge or application is not a priori known.

For example, there is a need in the art for production of musical excerpts for a plurality of uses such as advertising, promotion and selling recordings to mention a few. It is anticipated that there is a need in the art presently not available for on-line or even in store music shoppers to aurally peruse a music vendor's catalogue. By listening to characteristic recording extracts of the respective catalogue items instead of listening to original sound tracks, a wider range of source material would be available.

Also, the multitude of data produced by radio astronomic evaluations of space represents an interesting example of the problem of summarizing data. This field has a peculiar problem in that recorded radio astronomic data of the universe consists of sparse data events. Any kind of useful filter that has no a priori basis would seem an advance to the progress of radio astronomy. In this case, a researcher would be able to look at interesting natural events and perhaps even interesting life form originated events.

In addition, summaries of video recordings are often needed. The prior art of editing a film data series by examining a film data presentation virtually frame by frame to facilitate editing or shortening the length of a film is very tedious and costly. For the selling or hiring out of video films either on-line or even at specific outlets from economically produced film clips would also represent an advance.

Considering that summarizing fulfills the need to gather together the most relevant and most interesting portions of a data record. There are a number of other techniques that have sometimes been used to try to facilitate summaries, by trying to gather relevant portions of a data record but none has produced results of a sufficiently high standard. These are:

Fourier Transform: Fourier transforms (F.T.) are transformations of the data from position to wavelengths.

A_{O}≧sin Ok dx

This means that the F.T. measures waves, i.e. repetitions on some length scales. The relations between this and the Measure of Foreground Indicative complexity (MFIC), is that when there is a strong component of a specific wavelength (i.e. high amplitude) then the vocabulary usage of that size O will be extremely small, because of the repetitive nature of the sine function. However, the reverse is not the same. If there is a specific element size that has a low vocabulary usage, it does not mean that the amplitude of the corresponding wavelength will be large.

As a rule: Any function that relates to position (i.e. x, y of the data) will not produce the same results as MFIC, since MFIC doesn't care about position, only combinatorics.

Thus any Laplace, Fourier and other transformations of the kind:

A_{O}≧ƒOk dx

will not produce the same results as MFIC.

Fractal Analysis: A fractal, by definition, is a self-similar object, which means it is the same for different scales and resolutions. Thus, the computation of fractal analysis consists of comparing different scales and sizes of elements, which means it does not relate to Measure of Foreground Indicative Complexity (MFIC). However, when a fractal dimension is calculated, it could predict some features of the MFIC calculations. It would mean that vocabulary usages of different sizes would be the same, with the relation between the sizes being the fractal dimension.

It is significant that, at present, methods for providing summaries of data require substantial a priori knowledge and experience of both the subject being summarized as well as of an applied summarizing technique. Therefore, there is an ongoing need in the art for summarizing a wide variety of data, including but not limited to natural language text, on an effective, efficient and cost effective basis.

There remains a need in the art for an improved method for facilitating data summarizing; especially if such a method is operative without a priori knowledge of the target application.

### ADVANTAGES, OBJECTS AND BENEFITS OF THE INVENTION

Technical Issues: Presently available computer facilitated methods for summarizing data is not of a high standard. The present invention provides a method for summarizing a wide variety of data without requiring a priori knowledge of the subject matter. It is important to note that the present invention provides a significant advance for present techniques. An important aspect of the present invention is the selection of complex, important and significant sections of data, which allows the viewing of meaningful extracts.

Ergonomic Issues: Most significant in the methods for producing data summaries, is the ease of use and the necessity for prior knowledge of the subject or the procedure. In using the method suggested by the present invention, these significant aspects are overcome. For example, producing summary representing an author's thematic statements represents an improvement on selecting portions, which merely describe the background domain of knowledge.

Economic Issues: The cost of summarizing data is substantially high because of a number of reasons. Most summarizing techniques require training of personnel in the technique procedure and application. In addition, personnel performing summarizing, require substantial knowledge and training in the actual subject matter. Furthermore, there is an enormous amount of data being produced from data communication devices and systems. It is virtually impossible, if only from a time available point of view, for someone needing to access information, to perform a required task without having access to summary information presentations, unless additional time is spent. All aspects mentioned above are significantly costly and demonstrate the need in the art for an improved method for producing meaningful, accurate and effective summary data. The present invention represents a significant advance in summarizing techniques.

### Notices

Although the present invention is described herein with a certain degree of particularity those with an ordinary skill in the art will readily appreciate that various modifications and alterations may be carried out without departing from either the spirit or scope of the invention, as hereinafter claimed.

### Appendix A determination

### SUMMARY OF THE PRESENT INVENTION

One aspect of the present invention regards a computing environment accommodating at least one input device connectable to at least one server device connectable to at least one output device including a method of processing at least one information unit introduced by the at least one input device by the at least one server device to create at least one information summary unit based on the at least one information unit. The method consists of creating at least one complexity catalog based on the at least one information unit, and establishing at least one information summary unit based on the at least one complexity catalog.

A second aspect of the present invention regards a computing environment accommodating at least one input device connected to at least one server device having at least one output device and including a system for the processing at least one information unit introduced via the at least one input device by the at least one server device to create at least one information summary unit based on the at least one information unit. The system consists of an infrastructure server device to create at least one complexity catalog, a complexity catalog to hold at least one list of ordered complexity values associated with the partitioned sub-unit blocks, and an application server to build at least one information summary unit based on the at least one information unit and on at least one associated complexity catalog.

A third aspect of the present invention regards a pathology slide analysis system operative in the analysis of at least one pathology slide image taken of the cross-sections of body organs for the purpose of analysis and diagnosis. The system consists of a scanner device to scan selectively different portions of at least one pathology slide image and convert the resulting analog information into at least one digital image, and a processor device to process the resulting at least one digital image containing the information received from the scanner and to control the input parameters of the system in order to locate and display the pathological portions of the at least one pathology slide.

A fourth aspect of the present invention regards a pathology slide analysis method for the analysis of at least one pathology slide image taken of the cross-sections of body organs for the purpose of analysis and diagnosis. The method consists of normalizing the at least one digital image by the content value range of the image to an optimally processable value range in accordance with the range parameters value in the knowledge database, partitioning the at least one digital image into a pre-determined number of sub-unit blocks having a predetermined and equal size, calculating the complexity value of the sub-unit blocks in accordance with pre-defined parameter values and utilizing a pre-determined sequence of calculation steps, establishing a complexity metrics catalog to hold the complexity values associated with the sub-unit blocks constituting the at least one digital image, analyzing the content of the digital images in association with the complexity values assigned to the sub-unit blocks constituting the digital image, adaptively modifying the spatial coordinates of the moveable plate in order to expose different portions of the pathology slide to the recording device, adaptively modifying the magnification factor of the magnifying lens in order to facilitate selective concentration on the relevant portions of the pathology slide.

### BRIEF DESCRIPTION OF THE DRAWINGS

The present invention will be understood and appreciated more fully from the following detailed description taken in conjunction with the drawings in which:

FIG. 1 is a schematic block diagram of an exemplary computing and communications environment in which the method and system proposed by the present invention operates; and

FIG. 2 is a schematic block diagram of an exemplary infrastructure server; and

FIG. 3 is simplified flow chart illustrating the operation of the system and method of the present invention; and

FIG. 4 is a simplified flow chart illustrating the creation of the complexity file, in accordance with the first preferred embodiment of the present invention; and;

FIG. 5 is a flow chart illustrating the computation of the complexity value for a text block, in accordance with the first preferred embodiment of the present invention; and

FIGS. 6 and 7 are operationally sequential flow charts illustrating the production of the summary for a set of text records, in accordance with the first preferred embodiment of the present invention; and

FIG. 8 is a simplified flow chart illustrating the creation of the complexity file, in accordance with the second preferred embodiment of the present invention; and;

FIG. 9 is a flow chart illustrating the computation of the complexity value for an audio sub-record block, in accordance with the second preferred embodiment of the present invention; and

FIG. 10 is a flow charts illustrating the production of the summary for a set of audio records, in accordance with the second preferred embodiment of the present invention; and

FIG. 11 is a flow chart illustrating the creation of the complexity file, in accordance with the third preferred embodiment of the present invention; and;

FIG. 12 is a flow chart illustrating the complexity calculation, in accordance with the third preferred embodiment of the present invention; and

FIG. 13 is a flow chart illustrating the production of the summary for a set of video records, in accordance with the third preferred embodiment of the present invention; and

FIG. 14 is a schematic block diagram showing the creation of a combined summary file based on a video complexity file, an audio complexity file, and a text complexity file; and

FIG. 15 is a simplified flow chart illustrating the creation of the complexity file, in accordance with the fourth preferred embodiment of the present invention; and;

FIG. 16 is a flow chart illustrating the computation of the complexity value for a data block, in accordance with the fourth preferred embodiment of the present invention; and

FIG. 17 shows the components operative in the allocation of resources for the processing of the data blocks, in accordance with the fourth preferred embodiment of the present invention; and

FIG. 18 is a flow chart illustrating the comparison of different data files, in accordance with the fourth preferred embodiment of the present invention; and

FIG. 19 is a schematic illustration of a pathology slide analysis scanning scheme, in accordance with the fifth preferred embodiment of the present invention; and

FIG. 20 is a block diagram illustrating the principal elements constituting the system, in accordance with the fifth preferred embodiment of the present invention; and

FIG. 21 is a flow chart illustrating the components and functionality of the infrastructure server, in accordance with the fifth preferred embodiment of the present invention; and

FIG. 22 is a schematic block diagram of the knowledge database, in accordance with the fifth preferred embodiment of the present invention; and

FIG. 23 is a flow chart of the image modification procedure, in accordance with the fifth preferred embodiment of the present invention; and

FIG. 24 is a flow chart of the complexity value calculation, in accordance with the fifth preferred embodiment of the present invention; and

FIG. 25 is a flow chart of the operation of the scanner device, in accordance with the fifth preferred embodiment of the present invention; and

FIG. 26 is a schematic block diagram illustrating on-line analysis of data records from different information sources and having different format.

### DETAILED DESCRIPTION OF THE PREFERRED EMBODIMENTS

A novel method and system for summarizing information units is disclosed. In order to facilitate the selection of the most interesting and significant aspects from a collection of logically inter-related information units having diverse formats such as text, video, images, audio, graphics, database records and the like, are introduced into a computing environment. The information units such as data records are processed by a set of specifically designed and developed computer programs, which effect the division of the data records into fragments or blocks having substantially identical dimensionality. The division of the data records by the programs is performed in accordance with predetermined parameters associated with the format and/or the content of the data record collection. The dimensionally substantially identical fragments are assigned a complexity metric by a set of specifically designed and developed computer programs that compute the complexity value of the fragments in association with predetermined processing parameters. By dividing a composition of related data records into multiple like-size fragments, assigning the fragments a complexity value, and examining the most interesting and significant fragments of the data, it becomes possible to create a new summary view and/or a new perspective of the original information.

Methods, which require a prior knowledge of the application thereof, are substantially more complex and considerably more expensive to develop and to implement than methods that do not require a prior knowledge of their application. The principle is clearly demonstrated in the use of arithmetic and other computation techniques, which work successfully, regardless of to what purpose they are applied. Summarizing natural language text is a particular example of the preferred embodiments of the present invention because there is an ongoing and important need in the art to provide summaries of a wide range of textual compositions. Text is an example of a single-dimensional data structure. Slicing a stream of text into equal length segments, assigning a complexity metric to each segment and viewing the stream as a complexity metric series allows one to extract and provide a summary of the most significant aspects of the stream.

In accordance with the preferred embodiments of the present invention the proposed system and method are operative in the creation of a summary of a data record through the ordered performance of the following fundamental steps:

a) the acceptance of a data record; and

b) the division of the data record into fragments having substantially identical dimensionality; and

c) the assignment of a complexity metric to each of the substantially equal dimensional fragments.

The preferred embodiments of the present invention relate to a method for facilitating the selection of the most interesting or significant aspects, from a large group, set or collection of information. In dividing a composition into multiple like-size data fragments and examining the most interesting and significant fragments of data, it becomes possible to create a new summary view or a new perspective of the original information.

In this context, the concept of “interesting” and “significant” relate, generally, to the relatively most complex fragments of data. These most complex fragments have the highest metric of complexity and are vital to a local content event or data composition. Also, while these complex fragments are vital to an event or data composition, it is often important to include like dimensional “regions” proximate to these fragments to provide some element of continuity. It can be imagined that viewing a summarized fragment of a baseball game showing the moment of a batter hitting a home run, without showing the immediate consequence of the ball flying out of the field, would be most unsatisfactory.

Creating a summary of data is made feasible and is facilitated by the preferred embodiments to the present invention, in data dealing with single-dimensional, two-dimensional or multi-dimensional compositions. The procedure of splitting the document into equal length fragments, prescribing a complexity metric to each fragment and using those fragments, which are most complex and interesting, enables the production of an effective summary with sentences containing the highest frequency of high metrics. The preferred embodiments of the present invention do not preclude the use of word frequency criteria since these embodiments do not necessarily replace prior art, but do represent an improvement on the prior art.

The following description of the method and system proposed by the present invention includes several preferred embodiments of the present invention. Through the description of the embodiments specific useful applications are disclosed wherein the elements constituting the method process suitably the collection of data records associated with the application.

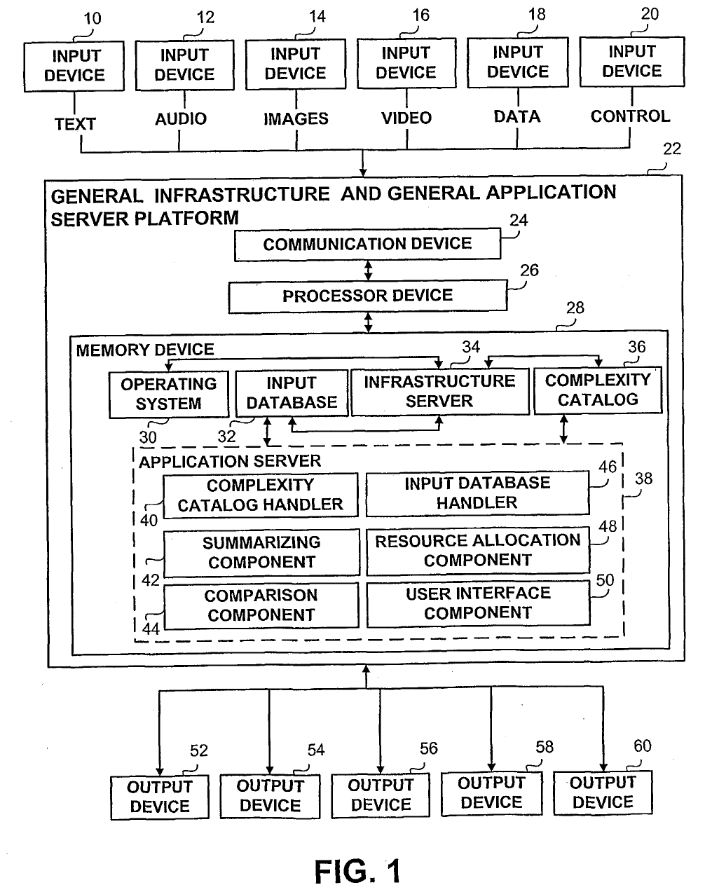

Referring now to FIG. 1 that shows a schematic block diagram of an exemplary computing environment suitable for the operation of the proposed method and system. The exemplary computing environment contains the principal hardware units and the main software components operative in the implementation of the proposed method. The described system includes a set of input devices 10, 12, 14, 16, 18, 20, an Infrastructure and Application Server Platform (IASP) 22, and a set of output devices 52, 54, 56, 58, 60.

The input devices 10, 12, 14, 16, 18, 20 are peripheral units of the proposed system that are operative in introducing the suitable data records and vital control information into the system. The input devices 10, 12, 14, 16, 18, 20 could be any of the standard input devices known in the art, such as a workstation terminal for example. The input devices 10, 12, 14, 16, 18, 20 include appropriate front-end components or interfaces through which suitable data records are inputted into the devices. The introduction of the data records could be done in a variety of ways; either manually, through appropriate actions performed by a human operator, or automatically by the utilization of diverse analog sensor units. The sensor units utilized could be analog phenomena sensing and recording units such as microphones, still cameras, video cameras, microscopes, telescopes, industrial, military, or medical monitoring equipment, and the like. The input devices 10, 12, 14, 16, 18, 20 could further include intermediate processing devices operative in accessing externally stored information structures, and in extracting the appropriate pre-processed data records having the suitable format from the external information structures. Locally stored information databases, remotely stored information files, such as Web pages, graphical files, video files, or the like, could also be utilized as sources of externally stored data. The data records thus obtained then could be introduced into the proposed system after further processing by the front-end components implemented in the input devices 10, 12, 14, 16, 18, 20. The input devices 10, 12, 14, 16, 18, 20 are linked either in a wireless or in a wired fashion to the IASP 22 in the standard manner known in the art. The devices 10, 12, 14, 16, 18, 20 could be connected to the platform 22 either locally such as in a Local Area Network configuration or remotely such as in a Wide Area Network configuration. Although for the purpose of clarity only a limited number of input devices are shown on the drawing under discussion it would be obvious that in a realistically configured system a plurality of input devices could be connected to the platform 22. Although for the purpose of clarity each separate input device is specifically associated with a particular data format on the drawing under discussion, it would be obvious that more that one input device could be associated with a particular data format and could be feeding the data to one or more separate applications. In addition a specific input unit could handle more than one data formats simultaneously and could feed several data format to one or more separate applications. In the most minimalist configuration the system could include a single input/output device handling a single data format, and connected to a single platform.

The IASP 22 is a hardware device such as a computer device having data storage, and data processing capabilities. The IASP 22 could have optional communication functions implemented therein. Diverse standard computing devices could be utilized as the IASP 22 such as hand-held computing devices, laptop devices, desktop devices, mainframe computer devices or any other device having the appropriate computing and communicating functionalities. The IASP 22 contains a processor device 26, an optional communications device 24, and a memory device 28. The processor device 26 is the logic circuitry designed to perform arithmetic and logic operations by responding to and processing the basic instructions driving the computing device. The device 26 is typically implemented on one or more printed circuit boards or silicon chips. Diverse processors could be installed within the IASP 22 such as the Pentium series, the PowerPC series, the K6 series, the Celeron, the Athlon, the Duron, the Alpha, or the like. The optionally installed communications device 24 is a hardware box including suitable electronic circuitry operative for establishing communication channels to remotely located components of the system such as remote input devices, remote output devices and remote computing platforms. The device 24 could be a standard modem device, a network interface card, or the like. The memory device 28 is a data storage unit such as a hard disk, floppy disk, fast tape device, ROM device, RAM device, DRAM device, SDRAM device, or the like. The device 38 stores the data structures and the software programs associated with the proposed method and system. The memory device 38 includes an operating system 30, an input database 32, an infrastructure server 34, an application server 38, and a complexity catalog 36. The operating system 30 is responsible for managing the operation of the entire set of software programs implemented in the system including the programs associated with the method proposed by the present invention. The operating system 30 could be any of the known operating systems such as Windows NT, Windows XP, UNIX, Linux, VMS, OS/400, AIX, OS X, or the like. The input database 32 is a specifically designed data structure that is operative in storing the data records provided by the input devices 10, 12, 1,4 16, 18, and 20. The database 32 could be organized such that the data records having different formats will be stored separately. For example the database 32 could have different levels where each level is associated with a specific data format such as text, images, video, audio, and the like. In addition, the database 32 could include levels designed to hold temporary or semi-temporary data structures during and after the processing of the information units. The infrastructure server 34 is a set of specifically designed and developed computer programs associated with the proposed method and system. The server 34 is operative in obtaining the data records, suitably processing the data records and in creating the complexity catalog 36. A detailed description of the operative components and functionally of the infrastructure server 34 will be given hereunder in association with the following drawings. The complexity catalog 36 is a data structure operative in holding the complexity metrics of the records received from the input devices 10, 12, 14, 16, 18, and 20 via the input database 32. Similarly to the input database 32 the complexity catalog 36 could be designed such as to be able to hold separately complexity metrics associated with different sets of data records in different formats. The database 32 and the catalog 36 could also support a number of different applications that implement the method and system proposed by the present invention. The application server 38 is a set of specifically designed and developed computer programs that suitably implement the preferred embodiments of the proposed method. The application server 38 is linked to the input database 32 and the complexity catalog 36. Although for the clarity of the description the drawing under discussion shows only a single application server it would be easily understood that in a practical configuration the platform 22 could contain a number of application servers in order to implement a number of different applications. Alternatively the server 38 could be designed such as to support multiple applications that could be operative in handling multiple sets of data records having diverse formats and provided by multiple input sources. The application server 38 includes an input database handler 46, a complexity catalog handler 40, a resource allocation component 48, a summarizing component 42, a comparison component 44, and a user interface component 50. The input database handler 46 is utilized for accessing the database 32 in order to obtain the suitable records for processing and/or in order to write the appropriate control records, temporary data, and the like back to the database 32. The complexity catalog handler 40 is responsible for the obtaining the appropriate complexity metrics records created by the infrastructure server 34 from the complexity catalog 36. The summarizing component 42 is responsible for summarizing the data records in accordance with the complexity metrics. The comparison component 44 is responsible for comparing specific data records in accordance with the complexity metrics. The resource allocation component 48 is responsible for allocating variable resources to the processing of the separate records in accordance with the complexity metrics thereof. The user interface component 50 is a set of specifically designed and developed front-end programs. The component 50 allows the user of the system to interact dynamically with the system by performing a set of predefined procedures operative to the running of the method. Thus, via the component 50 the user could select an application, activate the selected application, adjusting specific processing parameters, select sets of records for processing according to the complexity metrics thereof, and the like. The component 50 could be developed as a plug-in to any of the known user interfaces. The component 50 will be preferably a Graphical User Interface (GUTI) but any other manner of interfacing with the user could be used such as a command-driven interface, a menu-driven interface or the like.

For purposes of clarity the drawing under discussion includes a single ISAP 22 only and it is shown thereon that the entire set of software routines is co-located on the single platform 22. In realistic system configurations several platforms could be used for solving practical problems such as activating appropriate load balancing techniques for the enhancement of system performance and the like. Furthermore in a real system the IASP 22 will include additional hardware elements and software components in order to support the system and method proposed by the present invention or any other non-related applications implemented on the platform 22.

The set of output devices 52, 54, 56, 58, 60 are connected to the IASP 22 via wired or wireless links. The output devices 52, 54, 56, 58, 60 are operative in displaying the results of the applications such as summary records, comparison results, diagnosis, recommendations, and the like. The output devices 52, 54, 56, 58, 60 could be any of the standard output devices known in the art, such as a display screen, a plotter device, a printer, a speaker or the like. It would be easily understood that in certain system configurations such as one wherein workstations or personal computers are used as peripherals, the same devices could be utilized both for input and output. Some of the output devices could be operative in storing the results of the application in appropriate information structures. The system could be configured in such a manner as to include one or more remotely located output devices.

The set of input devices 10, 12, 14, 16, 18, 20, the IASP 22, and the set of output devices 62, 54, 56, 58, 60 could operate in diverse computing and optionally communicating environments having various existing configurations. Thus, a desktop computer controlled by a network management program could be used as well as a stand-alone mainframe computer controlled by a standard mainframe operating system, a Local Area Network (LAN) powered by a network management program such as Novell, of a Wireless Local Area Network (WLAN), a satellite communications network, a deep-space communications and control network, a cable television network, a cellular network, a global inter-network (Internet), any combination of the above, and the like.

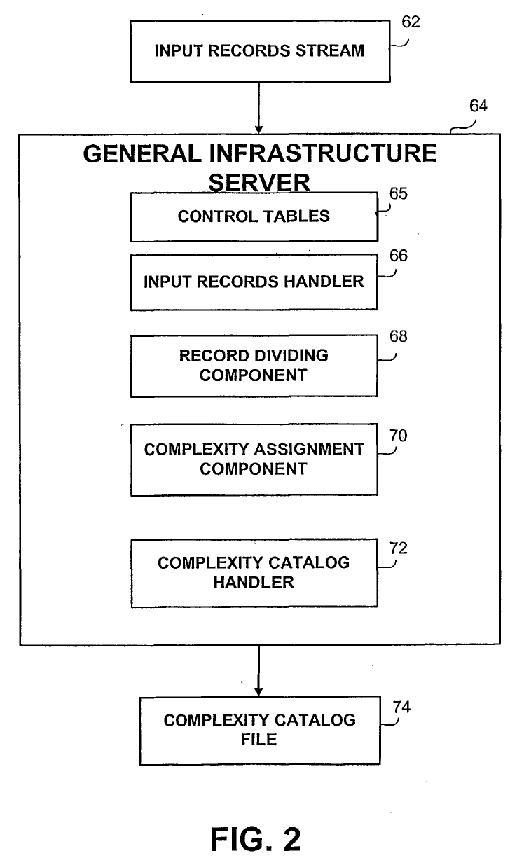

Referring now to FIG. 2 that illustrates the components constituting the exemplary infrastructure server. The server 64 accepts one or more input records from an input records stream 62. The input records stream 62 is provided to the server 64 via diverse input devices described hereinabove. The server 64 is a set of functional computer programs specifically designed and developed to implement the method and system proposed by the present invention. The server 64 includes an input records handler 66, a control table 65, a record dividing component 68, a complexity assignment component 70, and a complexity catalog handler 72. The input records handler 66 receives the input records from the input records stream 62 and provides the records to the record-dividing component 68. The record-dividing component 68 accepts the records, obtains the suitable control parameters from the control table 65, and divides the records into dimensional blocks having a size determined by the control parameters. Subsequently the dimensional blocks are provided to the complexity assignment component 70. The component 70 obtains the suitable control parameters from the control table 65, assigns appropriate complexity metrics to the records, and passes the complexity metrics records to the complexity catalog handler 72. The complexity catalog handler 72 inserts the complexity metrics records that include suitable pointers to the input records to the complexity catalog 74. The catalog 74 is a data structure holding the list of the complexity records for further processing.

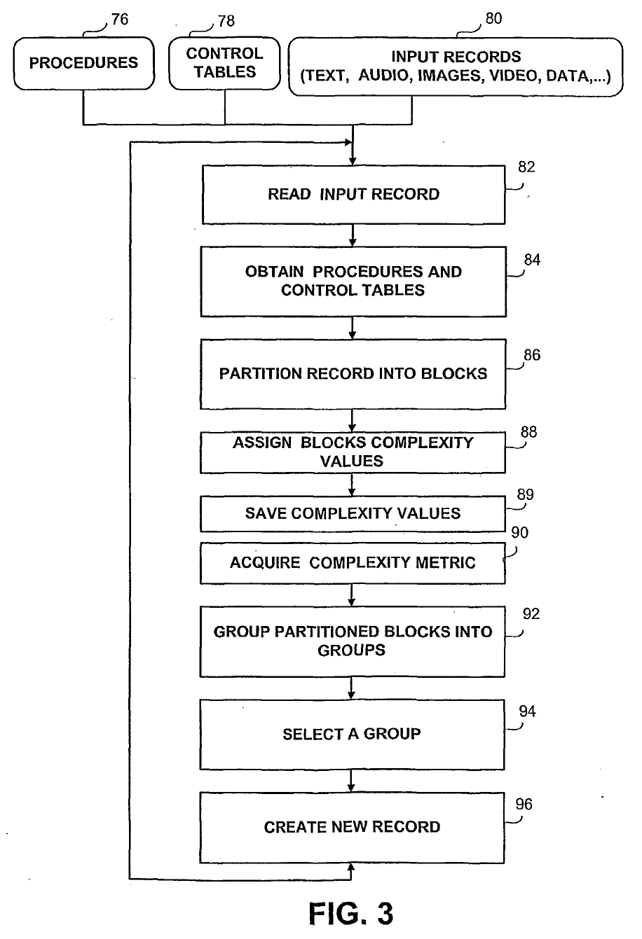

Referring now to FIG. 3, which a highly simplified flow chart illustrating the operation of the method and system proposed by the present invention. The method handles input records 80 having diverse formats such as text, audio, images, video, data, graphics, code such as applets, and the like. The processing of the input records 80 is performed by the specific executable procedures 76. The procedures 76 are program products specifically developed for the method and system proposed by the present application. The processing of the input records 80 is controlled by predetermined parameters stored in the control tables 78. The method is performed by the execution of successive steps that are defined within the procedures 76. These processing steps will be described next. At step 82 an input record is received from the input records 80. In accordance of the record format and/or the application type at step 84 the appropriate procedures and control parameters are read in. At step 86 the input record is divided into blocks and at step 88 the blocks are each assigned specific complexity values. Subsequently at step 89 the complexity values are saved into a complexity catalog. At step 90 the complexity catalog is obtained. At step 92 the blocks are organized into groups. The manner of the organization could be predetermined or could be dynamically decided upon by a) the system b) the user. The organization of the complexity records is done typically by sorting the complexity records in diverse sorting order, filtering the complexity records, merging the complexity records, or the like. Subsequent to the organization at step 94 one or more groups of complexity records are selected where the user of the system preferably does the selection. At step 96 a new summary record is created in order to be displayed to the user of the system.

The first preferred embodiment of the present invention deals with the production of data summaries for one or more sets of text records. Natural language text processing is a particular example of an application realized by the first embodiment of the present invention because there is an ongoing and important need in the art to provide summaries of a wide range of compositions. Text is an example of a single-dimensional data structure. Partitioning a stream of text into equal length segments, assigning a complexity metric to each segment and viewing the stream as a complexity metric series allows one to extract and provide a summary of the most significant aspects of the stream.

Currently, computer-summarizing techniques of text documents are inadequate. In Microsoft Word Software, the AutoSummarize feature is explained as picking out sentences that are most relevant to the theme of the document. Embodiments of the present invention will point to more interesting sentences. What Microsoft really means by “relevant” is the sentences that contain highest frequency occurring words in the document. In fact such sentences describe the background domain of knowledge, which would categorize the subject of the text and not the statement that the author wants to make about that subject. Embodiments of the present invention give a substantially better result.

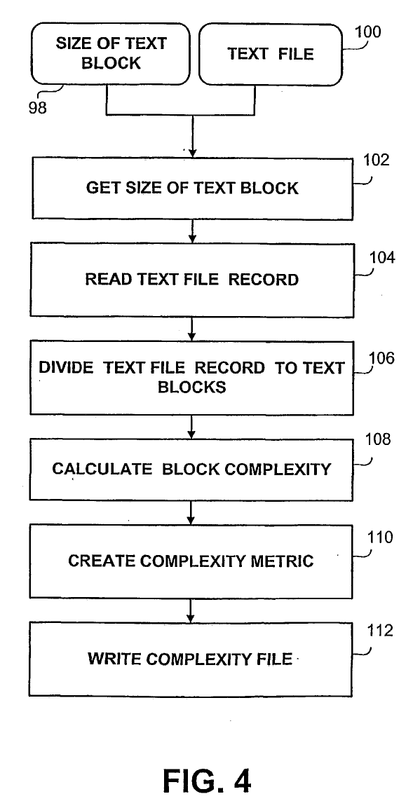

FIG. 4 is a flow chart describing the operation of the infrastructure server 64 of FIG. 2, in accordance with the first preferred embodiment of the present invention. The server 64 is responsible for the creation of the complexity file. The input to the procedure is a text file 100 preferably containing text documents and a parameter 98 that defines the size of the text block. The text file is connected to the method via the input devices 10, 12, 14, 16, 18, and 20 of FIG. 1. Optionally, the text file could be read by the method from one or more pre-processed text files stored on the platform 22 of FIG. 1 or any other platform in the computing environment connected to the platform 22 of FIG. 1 via wired or wireless links. The text file 100 will contain a plurality of characters. The set of characters includes alphanumeric characters of any conceivable language, control characters such as new line, tab, new page and the like. The size of text block parameter 98 is stored in the control tables 65 of FIG. 2. The parameter 98 defines the size of the blocks to be analyzed. The optimal value of the parameter 98 depends on the desired final output of the system. If the desired output is a summary then the value will be preferably less than the size of the summary. If the desired result is resource allocation then the value must be appropriate for the specific analyzing tools used. Further the value of the parameter 98 should be preferably larger than the length of a single sentence.

Still referring to FIG. 4 at step 102 the value of the size-of-text-block parameter 98 is obtained. At step 104 a text record is read and at step 106 the text record is divided into substantially equally sized text blocks where the size of the blocks is determined according to the value of the parameter 98. At step 108 the block complexity is calculated and at step 110 a complexity metric record is created. At step 112 the complexity record is written to the complexity file or complexity catalog 74 of FIG. 2. The steps 104 through 110 are executed once for each text record.

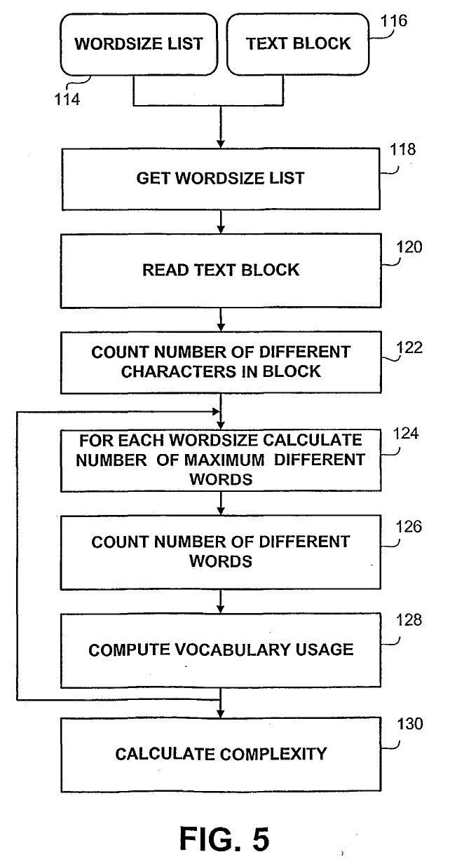

FIG. 5 is a flow chart of the complexity calculation, in accordance with the first preferred embodiment of the present invention. The input to the complexity calculation is a sub-divided text record or a text block 116. In order to properly calculate the complexity of the text block 116 a list of word sizes 114 is provided by a parameter stored in the control table 78 of FIG. 3. The word size list 114 could differ for each different language or could be defined universally. Basically the list includes integer values such as 1, 2, 3, 5, 6, and the like. For each word size the complexity calculation is performed and the appropriate U value is produced where U is the ratio of the number of different words present in the text block to the maximum possible words that could be present in the text block. Notes should be taken that the same word size should be associated with a given text file or else the complexity metric will not be correct. The comparison of the complexity metrics of two different files where the complexity calculations were performed with two different word size lists will be meaningless. The term “word” as used in the context of the first preferred embodiment of the present invention has no relation to the intuitively understood concept associated with the English counterpart thereof. “Word” in the current context refers to a group of adjacent characters in the text and does not refer to actual words in the text. For example in the proposed system and method “ty” is a “word” having a word size of 2 and “r. I am” of a “word” having a word size of 7.

Still referring to FIG. 5 at step 118 the wordsize list 114 is obtained. At step 120 the text block is read and at step 122 the number of different characters in the text block is calculated by the counting thereof. At step 124 a control loop including steps 124 through 128 is initiated. The loop will be executed once for each word size in the wordsize list. At step 124 the number of maximum different words is calculated in the following manner:

Max2=RF−WS(i)+1

Max1−RANGE to the WS(i)th power

MW=MIN(Max1, Max2)

Where RF is the size of the text block, WS(i) is the size of the ith member of the word size list, and RANGE is the number of different characters in the text block. Max1 represents the maximum possible words of a certain word size having a specific range. Max2 represents the maximum number of words in the current text block according to the size of the block and the word size. The MIN (minimum) function returns the smaller value of Max1 or Max2. The smaller value represents the maximum possible different words (MW). If Max1 is smaller then some words must repeat themselves. If Max2 is smaller then in the most complex text block all the different words will appear only once.

At step 126 the number of different words are counted and at step 128 the vocabulary usage (U) is computed.

U=WN/MW

Where WN is the number of different words and MW is the maximum possible words. Thus, U measures the ratio between the numbers of different words that appear in a text block to the maximum possible different words that could appear in a text block. If U has a small value then some words appeared many times while others did not appear at all. The essence of complexity is in this calculation. The more elements appear the higher the complexity metric of the text block. Following the completion of the handling of the entire list of the word sizes at step 130, program control exits the loop and the complexity calculation is performed in the following manner:

Complexity=PRODUCT U (i) [from i=1 to k]

Where k is the number of elements in the wordsize list. Thus, the complexity value is the product of the entire set of U's that were calculated for the different word sizes in the list of wordsizes 114.

Subsequent to the calculation of the complexity metric for the text blocks several applications could be selected, such as summary production, resource allocation, and comparison. The different applications will be described hereunder in association with the following drawings.

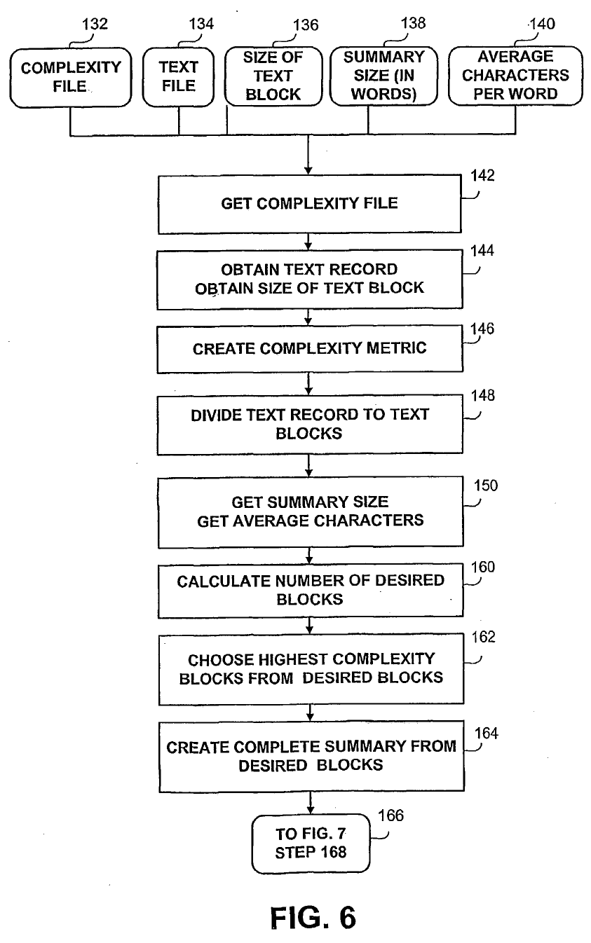

Referring now to FIG. 6, which illustrates via a simplified flow chart the production of the summary. The input for the procedure includes the complexity file 132, the text file 134, the size of the text block 136, the size of the desired summary in words 138, and the value of average characters per word 140. The size of the desired summary in words 138 is a predetermined value. The parameter 138 is set preferably dynamically by the user of the system. The average character per words 140 is a preset parameter value. At step 142 the complexity file 132 is obtained and at step 144 the suitable complexity metric is extracted from the complexity file. Subsequently at step 148 a text record from the text file 134 is partitioned into properly sized text blocks. At step 160 summary size 138 and the average characters per word 140 parameters are obtained. Next at step 160 the number calculated. The calculation is performed in the following manner:

DB=(SSW×ACW)/RF

Where RP is the size of the text block 136, SSW is the summary size in words 138, and ACW is the average characters per word 140. The result DB (Desired Blocks) is a subset of the set of text blocks having specific characteristics to be used as input to the summary creation.

Still referring to FIG. 6 at step 162 the text blocks are filtered such that only the highest complexity of blocks will be selected. The selected blocks will be inserted into a desired blocks list the membership thereof will be limited by the number of desired blocks. Consequently a complete summary is created from the desired blocks at step 164.

In order to create a meaningful summary preferably full sentences will have to be presented therein. Thus, subsequent to the collection of the blocks having high complexity value, the blocks are suitably edited in order to obtain the full sentences contained therein. However, if several adjacent blocks appear in the selected list of blocks, a sentence might span across several blocks. Thus, a sentence fragmented between the adjacent blocks preferably will have to be extracted suitably from all the blocks containing parts thereof and the extracted sentence fragments parts will have to be suitably re-assembled.

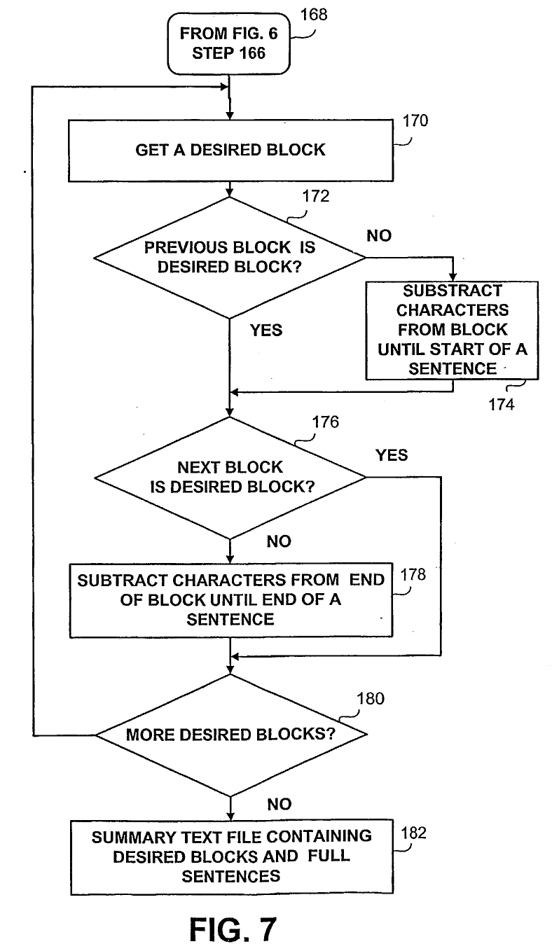

Turning now to FIG. 7, which a continuation flow chart sequentially following the flow chart presented on FIG. 6. At step 170 a desired block is read from the desired blocks list. At decision step 172 it is determined whether the previously read desired block is a desired block. If the result is negative then at step 174 all the characters from the beginning of the block to the start of a sentence are stripped and program control proceeds to determination step 176. If the result of decision step 172 is positive then program control proceeds directly to the determination step 176. At step 176 it is determined whether the next block is one of the desired blocks. If the result is negative then at step 178 all the characters positioned within the block from the end of a sequence until the end of the block are stripped and subsequently program control proceeds to determination step 180. If the result of decision step 176 is positive then program control proceeds directly to determination step 180. At step 180 it is determined whether there are more desired block to process. If the result is positive then the program control proceeds to step 170 in order to enter a program loop across steps 170 through 180. The loop is executed as long as there are more desired blocks to process. If at step 180 it is determined that all the desired blocks were processed then at step 182 a summary text file containing the desired blocks and full sentences is established.

The second preferred embodiment of the present invention deals with the production of data summaries for one or more sets of audio records. Recorded music processing is a particular example of the application of the second embodiment of the present invention because there is an ongoing and important need in the art to provide summaries produced from a plurality of recorded music records. Partitioning a stream of audio into equal length segments, assigning a complexity metric to each segment and listening to the stream as a complexity metric series allows one to extract and provide a summary of the most significant aspects of the stream. The method and system proposed by the present invention allows for the scanning of a plurality of recorded music sources and the forming of meaningful audio summaries.

The presently discussed embodiment can be applied to musical recordings, for example to symphonic movements. Dividing the recording into like sized fragments, allocating metrics with regard to highest complexity and grouping clusters of similar high complexity metrics can be used to produce a montage of musical highlights. It is possible to produce musical excerpts for many purposes. One such use is in advertising and in other applications requiring short musical interludes. It is anticipated that on-line music shoppers could auditorily peruse a music vendor's catalogue by listening to characteristic recording extracts of the respective catalogue items, wherein the extracts were produced using the second preferred embodiment of the present invention.

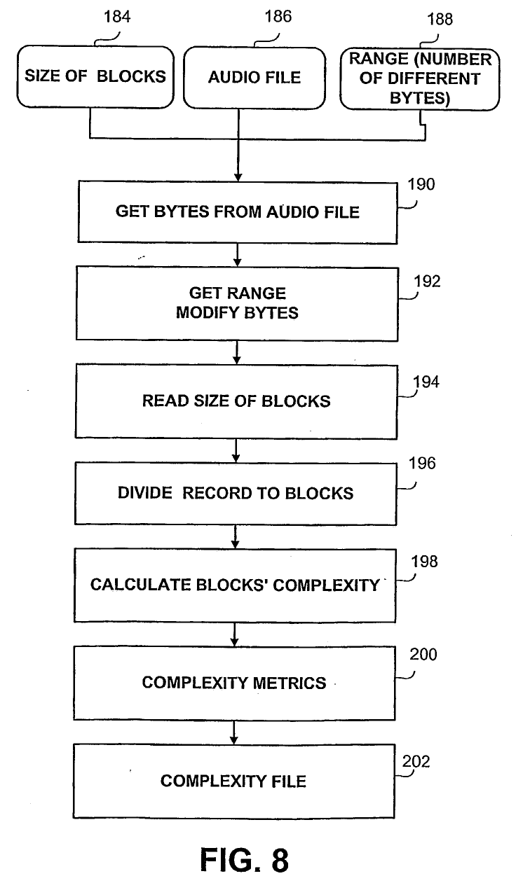

FIG. 8 is a flow chart describing the operation of the infrastructure server 64 of FIG. 2, in accordance with the second preferred embodiment of the present invention. The server 64 is responsible for the creation of the complexity file. The input to the procedure is an audio file 186 preferably containing audio records, a parameter 184 defining the size of the sub-record audio blocks, and a parameter defining the number of different bytes. The audio file is connected to the method via the input devices 10, 12, 14, 16, 18, and 20 of FIG. 1. Optionally, the audio file could be read by the method from one or more pre-processed audio files stored on the platform 22 of FIG. 1 or any other platform in the computing environment connected to the platform 22 of FIG. 1 via wired or wireless links. The audio file 186 will contain a plurality of bytes. The size of sub-record audio block parameter 184 is stored in the control tables 65 of FIG. 2. The parameter 184 defines the size of the blocks to be analyzed. The optimal value of the parameter 184 depends on the desired final output of the system. If the desired output is a summary then the value will be preferably less than the size of the summary. If the desired result is resource allocation then the value must be appropriate for the specific analyzing tools used. In order to achieve optimum analysis of the complexity preferably a range of bytes will be set. In a characteristic audio files the range parameter 188 is typically about 256. This value is inappropriate for the processing of a video file by the proposed system and method as it will calculate an extremely high value for the maximum possible words with the word size having 256 bytes and as a result all the sub-record audio blocks will have a complexity value of 1. Thus, in order to obtain meaningful differences among the various complexity metrics preferably re-evaluation of the available range values will have to be performed.

In the second preferred embodiment of the invention the typical range value will be about 10. According to the different types of the audio files different ranges could be set. For example the typical range values of about 0 to 256 will be preferably re-evaluated to the range values of about 0 to 10.

Still referring to FIG. 8 at step 190 the bytes constituting the audio record is obtained. At step 192 the range parameter 188 is extracted from the control table 78 of FIG. 2 and the audio bytes are suitably modifying. At step 194 the value of the size-of-sub-record-block parameter 184 is obtained. At step 106 the audio record is divided into sub-record audio blocks according to the value of the parameter 184. At step 198 the block complexity is calculated and at step 200 a complexity metric record is created. At step 202 the complexity record is written to the complexity file or complexity catalog 74 of FIG. 2. The steps 104 through 110 are executed once for each audio record.

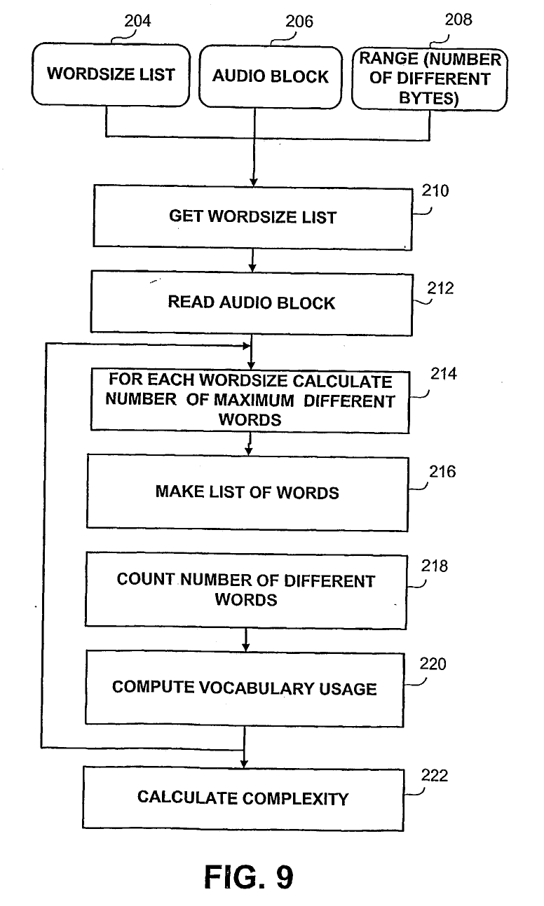

FIG. 9 is a flow chart of the complexity calculation, in accordance with the second preferred embodiment of the present invention. The input to the complexity calculation is a sub-divided audio record or a sub-record audio block 206. In order to properly calculate the complexity of the audio block 206 a list of word sizes 204 is provided by a parameter stored in the control table 78 of FIG. 3. The wordsize list 204 could differ for each type of audio file or could be defined universally. Basically the list includes integer values such as 1, 2, 3, 5, 6, and the like. For each wordsize the complexity calculation is performed and the appropriate U value is produced where U is the ratio of the number of different words present in the audio block to the maximum possible words that could appear in the audio block. Notes should be taken that the same word size should be associated with a given audio file or else the complexity metric will not be correct. The comparison of the complexity metrics of two different audio files where the complexity calculations were performed with two different word size lists will be meaningless.

Still referring to FIG. 9 at step 210 the wordsize list 204 is obtained. At step 212 the audio block is read and at step 214 the number of different characters in the audio block is calculated by counting. At step 214 a control loop including steps 214 through 220 is initiated. The loop will be executed once for each word size in the wordsize list. At step 216 the number of maximum different words is calculated in the following manner:

Max2=RF×WS(i)+1

Max1=Range to the WS (i)th power

MW=MIN (Max1, Max2)

At step 220 the number of different words are counted and at step 128 the vocabulary usage (U) is computed.

U=WN/MW

Following the completion of the handling of the entire list of the word sizes at step 222, program control exits the loop and the complexity calculation is performed in the following manner:

Complexity=PRODUCT U(i) [from i=1 to k]

Where k is the number of elements in the word size list. Thus, the complexity value is the product of the entire set of U's that were calculated for the different word sizes in the list of word sizes 204.

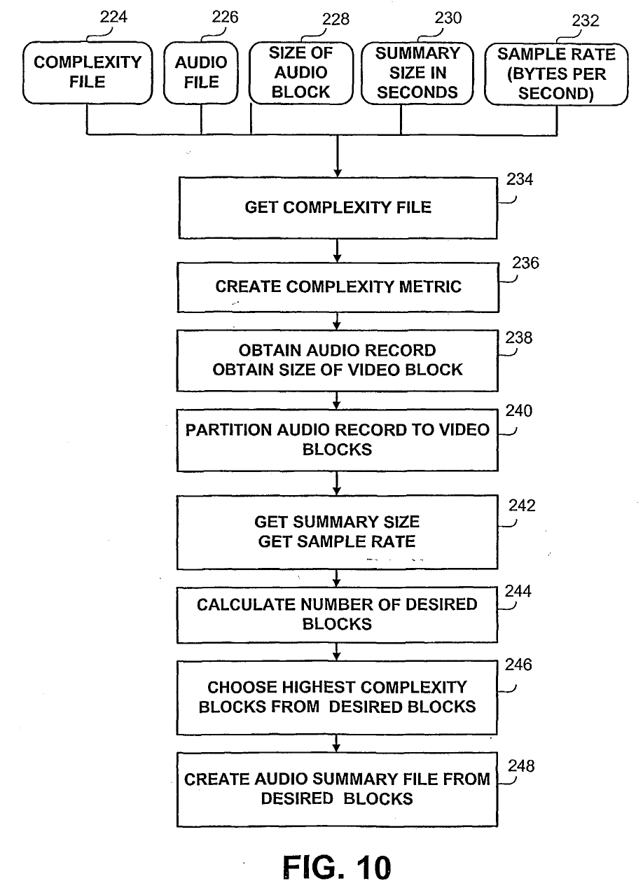

Referring now to FIG. 10, which illustrates via a simplified flow chart the production of an audio summary. The input for the procedure includes the complexity file 224, the audio file 226, the size of the sub-record audio block 228, the size of the desired summary in seconds 230, and the sample rate expressed in bytes per second (bps) 232. The size of the desired summary in seconds 230 is a predetermined value. The parameter 230 is set preferably dynamically by the user of the system. The sample rate 232 is a preset parameter value. At step 234 the complexity file 224 is obtained and at step 236 the suitable complexity metric is extracted from the complexity file. Subsequently at step 240 an audio record from the audio file 226 is partitioned into properly sized sub-record audio blocks. At step 242 summary size 230 and the sample rate 232 parameters are obtained. Next at step 244 the number of desired blocks calculated. The calculation is performed in the following manner:

DB=(SSR×SR)/RF

Where RF is the size of the audio block 228, SSR is the summary size in seconds 230, and SR is the sample rate 232. The result DB (Desired Blocks) is a subset of audio blocks having specific characteristics to be used as input to the summary creation.

Still referring to FIG. 10 at step 246 the audio blocks are filtered such that only the highest complexity of blocks will be selected. The selected blocks will be inserted into a desired blocks list the membership thereof will be limited by the number of desired blocks. Consequently a complete audio summary is created from the desired blocks at step 248.

The third preferred embodiment of the present invention deals with the production of data summaries for one or more sets of video records. The processing of recorded video records is a particular example of the application of the third embodiment of the present invention because there is an ongoing and important need in the art to provide video summaries produced from a plurality of recorded video information. Partitioning a stream of video into equal length segments, assigning a complexity metric to each segment and listening to the stream as a complexity metric series allows one to extract and provide a video summary of the most significant aspects of the stream. The method and system proposed by the present invention allows for the scanning of a plurality of recorded video sources and the forming of useful and meaningful video summaries.

A particular application of third embodiment for preparing film clips that can be used to facilitate the selling or hiring out of video films either on-line or at specific retail outlets. By a vendor producing a collage of clips from several similar category films, a potential customer is able to view, say, fifteen-second clips from each movie, to facilitate selecting one of his choices.

To prepare a summarized video film clip from a video recording of a long sports event for screening merely significant highlights is another example of an application of the third embodiment. By slicing the video recording into like length sections, allocating a complexity metric to each section and collating the sections of highest metrics, it is possible to create a single or even a series of highlights of the game. Highlights are frequently inserted into news broadcast presentations, where only an amount limited of time is available.

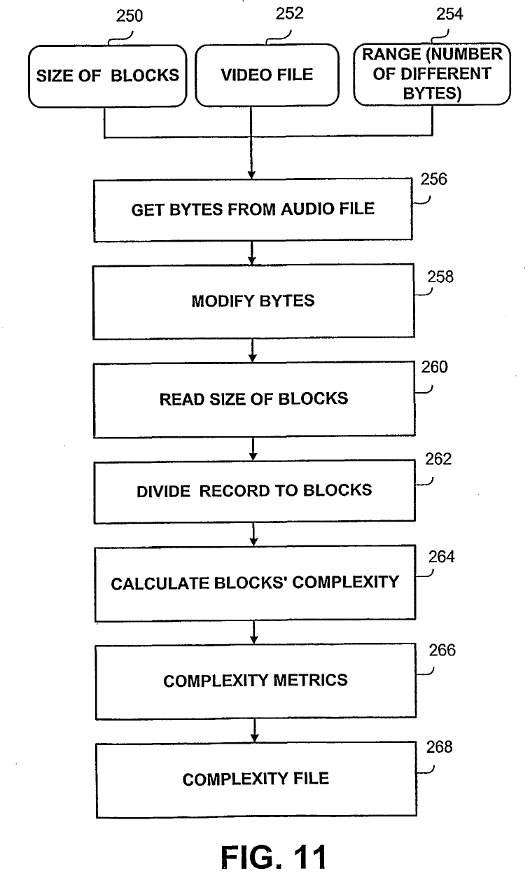

FIG. 11 is a flow chart describing the operation of the infrastructure server 64 of FIG. 2, in accordance with the third preferred embodiment of the present invention. The server 64 is responsible for the creation of the complexity file. The input to the procedure is a video file 252 preferably containing video records, a parameter 250 defining the size of the sub-record video blocks, and a range parameter 254 that defines the number of different bytes in the video file. The video file is connected to the method via the input devices 10, 12, 14, 16, 18, and 20 of FIG. 1. Optionally, the video file could be read by the method from one or more pre-processed video files stored on the platform 22 of FIG. 1 or any other platform in the computing environment connected to the platform 22 of FIG. 1 via wired or wireless links. The video file 252 will contain a plurality of bytes. The value of the parameter defining the size of sub-record video block parameter 250 is stored in the control tables 65 of FIG. 2. The parameter 250 defines the size of the video blocks to be analyzed. The optimal value of the parameter 250 depends on the desired final output of the system. If the desired output is a summary then the value will be preferably less than the size of the summary. If the desired result is resource allocation then the value must be appropriate for the specific analyzing tools used.

Still referring to FIG. 11 at step 256 the bytes constituting the video file 252 are obtained from the video file 252. At step 258 for each byte a suitable calculation is made in order to modify the bytes. At step 260 the value of the size-of-video-block parameter 250 is obtained. At step 262 the video record is divided into video block according to the value of the parameter 250. At step 264 the block complexity is calculated and at step 266 a complexity metric record is created. At step 268 the complexity record is written to the complexity file or complexity catalog 74 steps 104 through 110 are executed once for each text record.

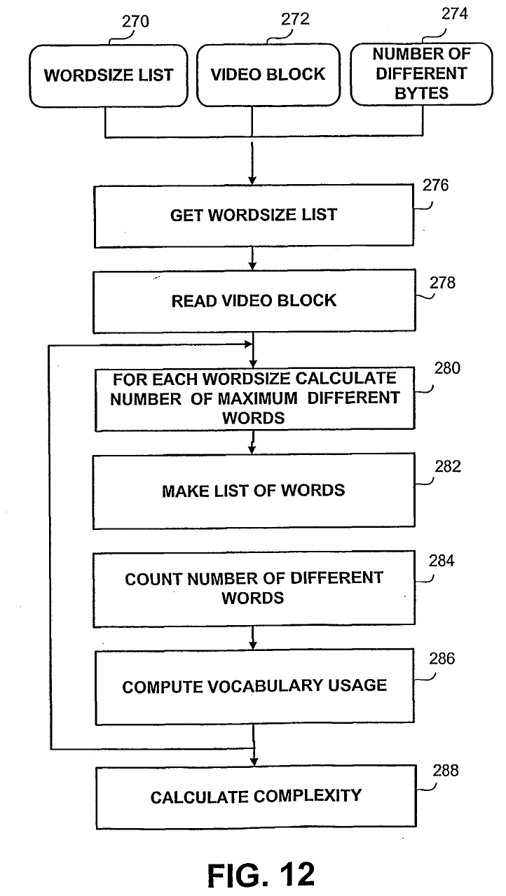

FIG. 12 is a flow chart of the complexity calculation, in accordance with the third preferred embodiment of the present invention. The input to the complexity calculation is a sub-divided video record or a video block 272. In order to properly calculate the complexity of the video block 272 a list of word sizes 270 is provided by a parameter stored in the control table 78 of FIG. 3. The wordsize list 270 could differ for each different type of video format. Basically the list includes integer pair values such as (1,2), (2,2), (3,2), (5,1), (6,6), and the like. For each word size the complexity calculation is performed and the appropriate U value is produced where U is the ratio of the number of different words present in the video block to the maximum possible words that could appear in the video block. Notes should be taken that the same word size should be associated with a given video file or else the complexity metric will not be correct. The comparison of the complexity metrics of two different files where the complexity calculations were performed with two different wordsize lists will be meaningless.

Still referring to FIG. 12 at step 276 the wordsize list 270 is obtained and at step 278 the video block is read. At step 280 a control loop including steps 280 through 286 is initiated. The loop will be executed once for each wordsize in the wordsize list 270. At step 280 the number of maximum different words is calculated in the following manner:

Max2=(x−WS1(i)+1)×(y−WS2(i)+1)×RF

Max1=RANGE to the (WS1(i)th×WS2(i)th)power

MW=MIN(Max1, Max2)

At step 284 the number of different words are counted and at step 286 the vocabulary usage (U) is computed.

U=WN/MW

Where WN is the number of different words and MW is the maximum possible words. Thus, U measures the ratio between the numbers of different words that appear in a video block to the maximum possible different words. If U is small then some words appeared many times while others did not appear at all.

The essence of complexity is in this calculation. The more elements appear the higher the complexity metric of the video block.

Following the completion of the handling of the entire list of the word sizes at step 288, program control exits the loop and the complexity calculation is performed in the following manner:

Complexity=PRODUCT U(i) [from i=1 to k] Where k is the number of elements in the word size list. Thus, the complexity value is the product of the entire set of U's that were calculated for the different word sizes in the list of word sizes 270.

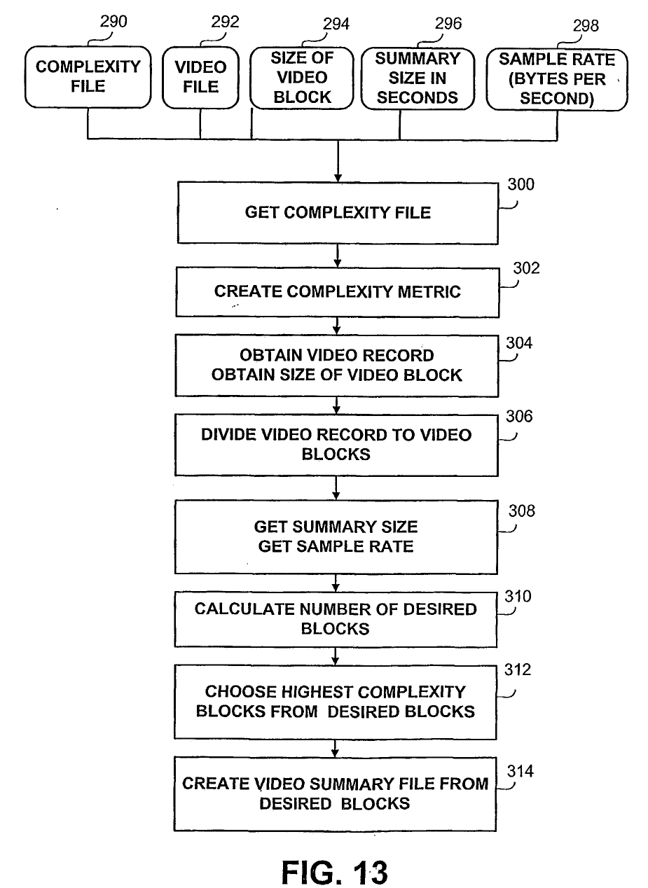

Referring now to FIG. 13, which illustrates via a simplified flow chart the production of the video summary. The input for the procedure includes the complexity file 290, the video file 292, the size of the video block 294, the size of the desired summary in seconds 296, and the sample rate parameter 298 expressed in bytes per second. The size of the desired summary in seconds 296 is a predetermined value. The parameter 296 is set preferably dynamically by the user of the system. The sample rate 298 is a preset parameter value. At step 300 the complexity file 290 is obtained and at step 302 the suitable complexity metric is extracted from the complexity file. Subsequently at step 304 a video record is obtained from the video file 292 and the size of the video block is read from the blocksize parameter 294. At step 306 the video record is partitioned into properly sized video blocks. At step 308 the summary size parameter 296 and the sample rate 298 parameter are obtained. Next at step 310 the number of the desired blocks is calculated. The calculation id performed in the following manner:

DB=(SSS×SR)/RF

Where RF is the size of the video block 136, SSS is the summary size in seconds 296, and SR is the sample rate 298. The result DB (Desired Blocks) is a subset of video blocks having specific characteristics to be used as input to the video summary creation.

Still referring to FIG. 13 at step 312 the video blocks are filtered such that only the highest complexity of blocks will be selected. The selected blocks will be inserted into a desired blocks list the membership thereof will be limited by the number of desired blocks. Consequently a complete video summary is created from the desired blocks at step 314.

Typically video files include encoded audio elements in addition to the visual elements. Some audio data includes non-articulate sounds, such as natural sounds, music, and the like. Audio data also includes articulate components, such as human speech, which are transformable into structured text format. The method and system of the present invention enables the parallel processing of the video elements, the audio elements, and the text-related elements of a typical video file substantially simultaneously and in a parallel manner in order to create specific video complexity/audio complexity/text complexity files. The separate complexity files are utilized to create a video summary where the summary records are based on all the different formats constituting the video file.

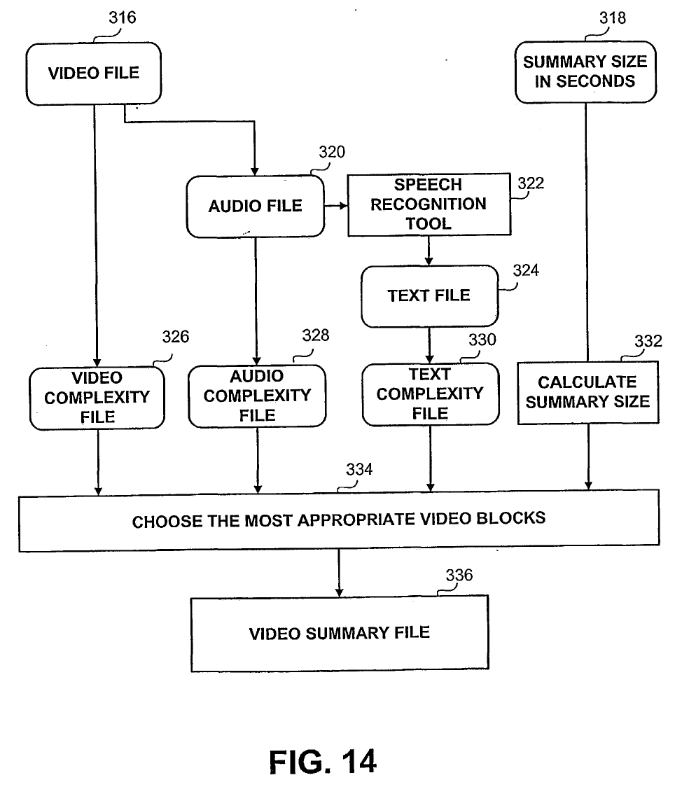

Referring to FIG. 14, which illustrates the production of an enhanced video summary based on the complexity values of the video elements, the audio elements, and the text elements of a video file. A video file 316 is appropriately processed by suitable analog filters or equivalent Digital Signal Processing (DSP) devices in order to extract the audio elements from the file. The video elements effect the production of a separate audio file 320. A speech recognition tool 322 is utilized to process the audio file 320 in order to recognize articulate audio elements (such as human speech) within the audio file, which are characterized by the potentiality of being allowed to be transformed into pure text. As a result of the speech recognition processing a text file 324 could be created. The video file 316 is processed in order to create a video complexity file 326. The audio file 320 is used as an input to an audio complexity calculation that produces the audio complexity file 328. The text file 324 is used as input to a text complexity calculation that will assign complexity values to the appropriate sub-text blocks and will create a text complexity file 330. A summary size parameter value 318 is used to calculate the combined summary size 332. Next the most appropriate blocks of video are selected for the summary according to the video complexity, the audio complexity, and the text complexity where each of the complexity elements is assigned a predetermined weight. Consequently a suitable video summary file 336 is produced.

The fourth preferred embodiment of the present invention deals with the production of summaries for one or more sets of data records A specific application of the suggested method involves the analysis of a large multi-dimensional data warehouse for data mining purposes. The individual data records could also be multi-dimensional. Partitioning the records of the data into equal length segments, assigning a complexity metric to each segment and viewing the records as a complexity metric series allows one to extract and provide a summary of the most significant aspects of the data warehouse.

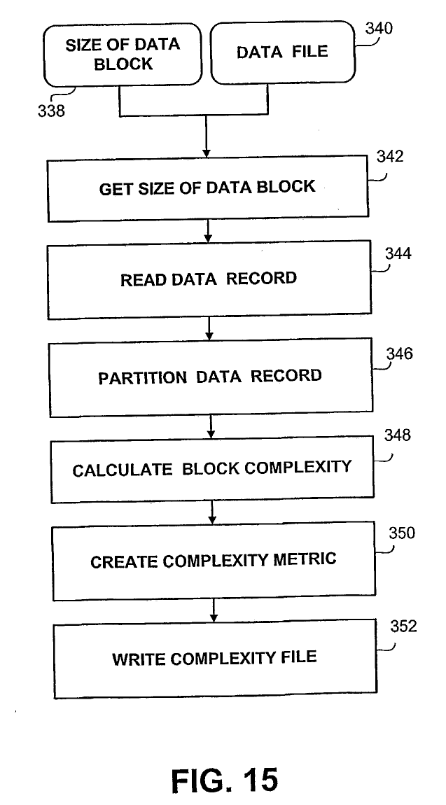

FIG. 15 is a flow chart describing the operation of the infrastructure server 64 of FIG. 2, in accordance with the fourth preferred embodiment of the present invention. The server 64 is responsible for the creation of the complexity file. The input to the procedure is a data file 340, and a parameter 338 defining the size of the data block. The data file is connected to the method via the input devices 10, 12, 14, 16, 18, and 20 of FIG. 1. Optionally, the data file could be read by the method from one or more pre-processed databases stored on the platform 22 of FIG. 1 or any other platform in the computing environment connected to the platform 22 of FIG. 1 via wired or wireless links. The data file 340 will contain a plurality of data fields where each field has a specific value The size of data block parameter 338 is stored in the control tables 65 of FIG. 2. The parameter 338 defines the size of the data blocks to be analyzed. The optimal value of the parameter 338 depends on the desired final output of the system. If the desired output is a summary then the value will be preferably less than the size of the summary. If the desired result is resource allocation then the value must be appropriate for the specific analyzing tools used. Further the value of the parameter 338 should be preferably larger than the length of a single field.

Still referring to FIG. 15 at step 342 the value of the size-of-data-block parameter 338 is obtained. At step 344 a data record is read and at step 346 the data record is divided into data blocks according to the value of the parameter 338. At step 348 the data block complexity is calculated and at step 350 a complexity metric record is established. At step 352 the complexity record is written to the complexity file or complexity catalog 74 of FIG. 2. The steps 344 through 352 are executed once for each data record.

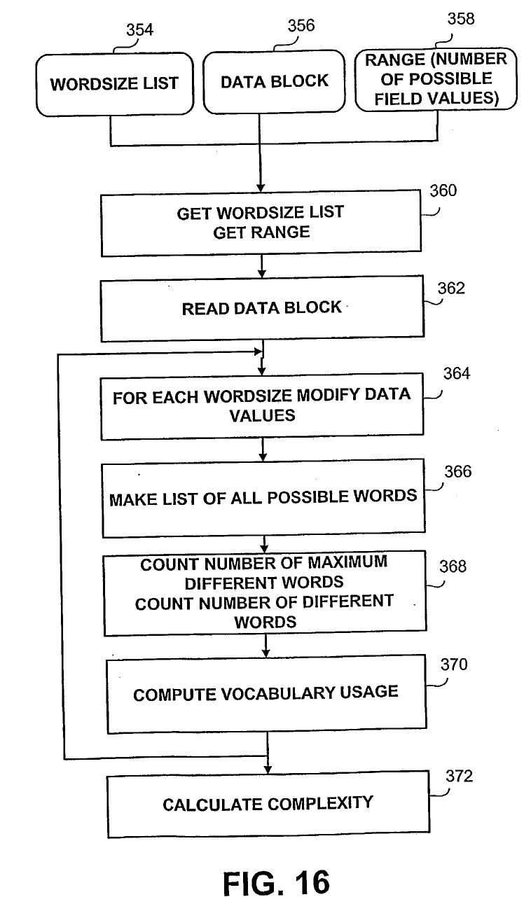

FIG. 16 is a flow chart illustrating the complexity value calculations regarding the data blocks, in accordance with the fourth preferred embodiment of the present invention. The input, to the complexity calculation is a sub-divided data record or a data block 356. In order to properly calculate the complexity of the data block 356 a list of word sizes 354 is provided by a parameter stored in the control table 78 of FIG. 3. The wordsize list 354 could differ for each different language or could be defined universally. Basically the list includes integer values such as 1, 2, 3, 5, 6, and the like. For each word size the complexity calculation is performed and the appropriate U value is produced where U is the ratio of the number of different words present in the data block to the maximum possible words that could appear in the text block. Notes should be taken that the same word size should be associated with a given data file or else the complexity metric will not be correct.

Still referring to FIG. 16 at step 360 the wordsize list 354 is obtained. At step 361 the value of the parameter defined as number of possible values is obtained and at step 362 the data block is read. Next, at step 364 the program control initiates an execution loop across steps 364 through 370. The loop is executed once for each available word size. Within the loop at step 364 the data block values are modified and at step 366 a list of all possible words is made. The modification of the data field values is made in the following manner:

NewValue=((OldValue−Min(Value)/(Max(Value)−Min(Value))×Number of Possible Values

At step 368 the number of maximum different words is calculated. At step 338 the number of different words are also counted and at step 370 the vocabulary usage (U) is computed.

U=WN/MW

Following the completion of the handling of the entire list of the word sizes at step 372, program control exits the loop and the complexity calculation is performed in the following manner:

Complexity=PRODUCT U(i) [from i=1 to k]

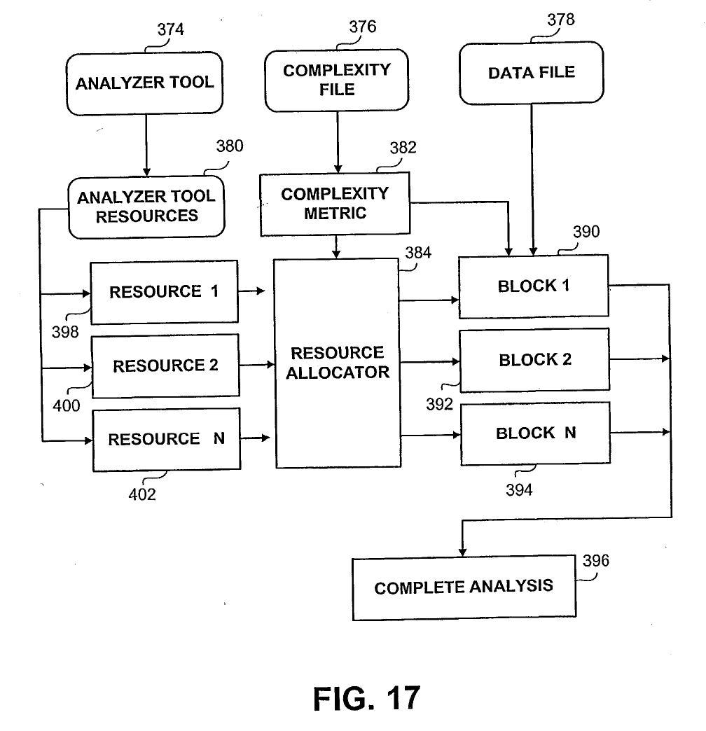

Referring now to FIG. 17, which illustrates via a simplified flow chart the resource allocation process. The analyzer tool 374 controls a limited number of analyzer tool resources 380 such as resource 1 (398), resource 2 (400), and resource N (402). The resources 398, 400, 402 are allocated 386 to the processing of the blocks 390, 392, 394 obtained from the data file 378 by the resource allocator 384. The blocks are associated with the complexity records 382 that are obtained from the complexity file 376. The resource allocator 384 assigns resources for the processing of the blocks 390, 392, 394 according to the complexity metrics 382 associated with the blocks 390, 392, 394. In order to enhance performance more resources are assigned to blocks having high complexity value than to blocks with lower complexity values.

By comparing two different complexity data files such as produced from the same data at different times, the changes in the complexity of the files could be discerned. The information thus obtained could be utilized to alert a user or to be used as input for an analyzing process to recognize specific patterns of behavior.

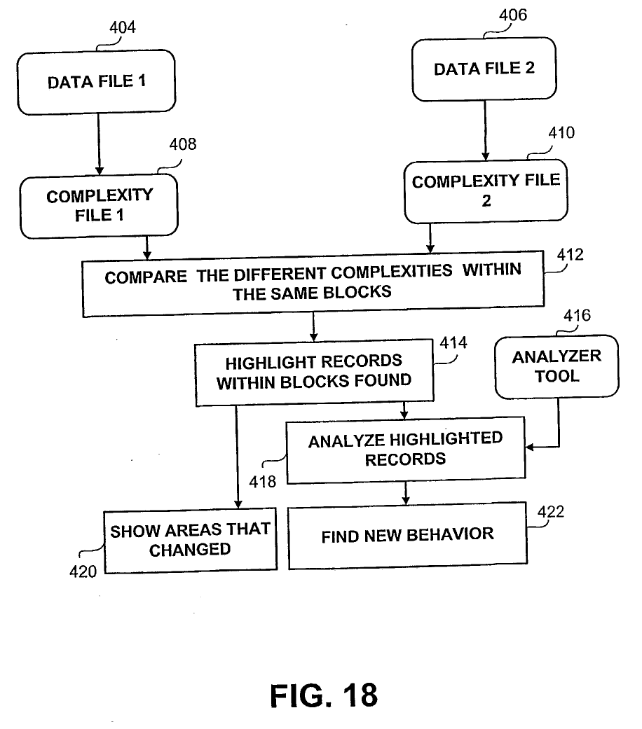

FIG. 18 illustrates the data comparison procedure. The comparison is performed between a data file 1 (404) and a data file 2 (406). Typically these two files will relate to the two sets of information units associated with an identical location and will be recorded within different time windows. The infrastructure server 34 of FIG. 1 will process the data file 1 (404) and the data file 2 (406) and as a result the complexity file 408 and the complexity file 410 respectively will be produced. Then a data block associated with the data file 1 (404) will be complexity-wise compared to an equivalent data block associated with the data file 2 (406). The blocks with a different complexity value will be marked appropriately and analyzed by an analyzer tool 416. Changed blocks could be displayed to the user 420 and a new pattern of behavior could be discerned (422).

The fifth preferred embodiment of the preset invention deals with the analysis of pathology slides that include recorded information of body organs.

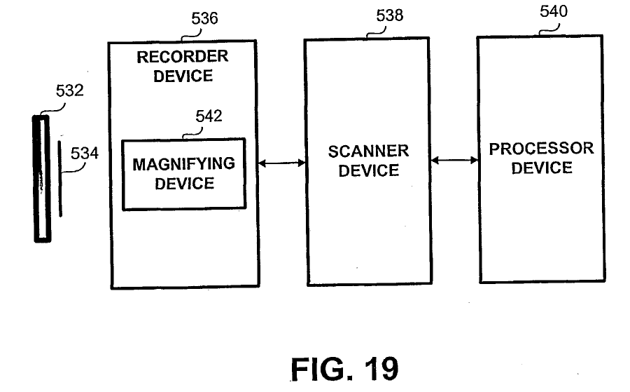

Pathology slides are images taken of the cross-sections of body organs for the purpose of analysis and diagnosis. FIG. 19 illustrates the scanning scheme of the pathology slide analysis system. On moving plate 532 a pathology slide 534 is placed. The slide 534 is recorded by a recorder device 536 such as a camera that utilizes a magnifying device 542 such as a microscope lens. The image of the slide 534 is scanned by a scanner device 538 and the results are send as a digital file to a processor device 540 such as a microprocessor.

The scanning device uses the complexity calculation of the image taken to magnify and move the pathological slide to more “interesting” areas. Thus, if a high complexity area in the image is established then the scanning device increases the magnification and moves to that area to explore it further. Thus the complexity calculation has a substantial influence on the characteristics of the series of images recorded.

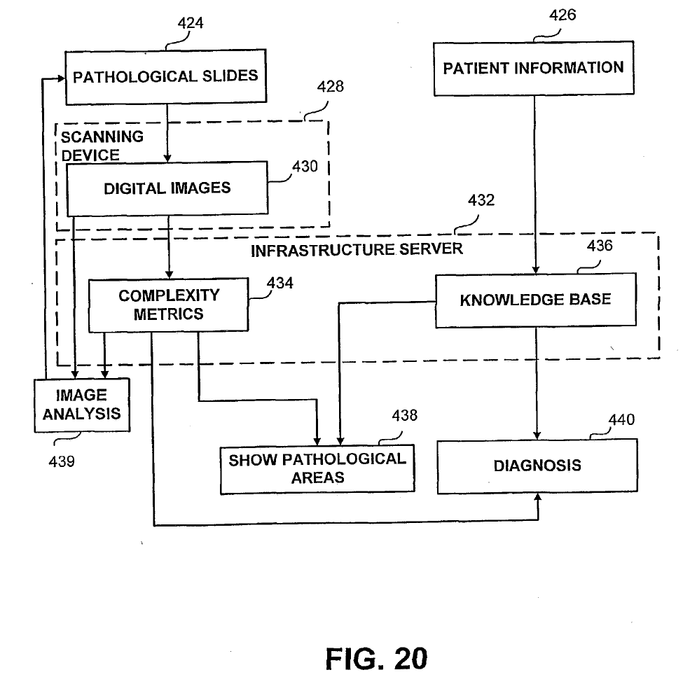

Referring now to FIG. 20 that illustrates an exemplary configuration of the pathology slides analysis system. A scanning device 428 scans one or more pathology slides 424. The analog images of the slides are converted into digital images 430. The digital images 430 are fed to an infrastructure server 432 that processes the images using known Digital Signal Processing (DSP) techniques in order to produce the complexity metrics 434 associated with the images 430.

Specific patient information 426 is sent to a knowledge database 436 associated with the infrastructure server 432. The detailed structure of the knowledge database will be described hereunder in association with the following drawings. The knowledge database 436 supplies the appropriate parameters to the application that displays the suitable complex pathological areas to the user. In addition a diagnosis 440 could be made. The complexity metrics 434 is providing complexity information to an image analysis unit 439 that will determine the relevant areas and will notify the scanning device 428 thereabout. Consequently the scanning device could to enhance the scan regarding the relevant areas of the pathological slides 424.

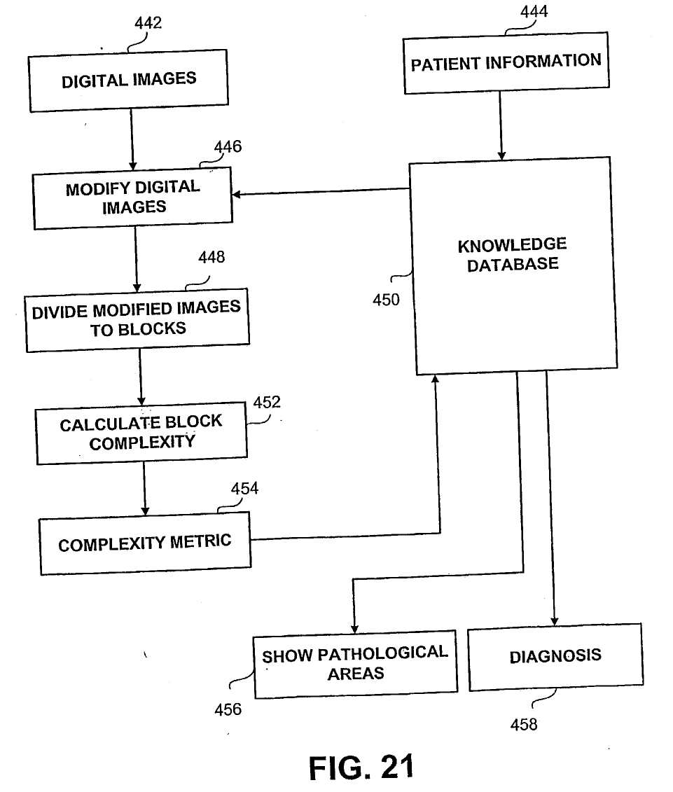

FIG. 21 is a flow chart illustrating the structure and functionality of the infrastructure server 432 of FIG. 20. The knowledge database 450 contains patient information 444 and parameters regarding the normalization of the digital images 442. The images 442 are modified accordingly at step 446. Next, the modified images are divided into image blocks where the partitioning process is controlled by relevant parameters obtained from the knowledge database 450. At step 452 the complexity value of the image blocks is computed and each block is assigned a complexity value. At step 454 the complexity metrics of each block is stored in a complexity file within the knowledge database 450. The knowledge database 450 provides information for the display of pathological areas to user 465 and for optionally provides diagnosis 458. The diagnosis 458 is based on the entire set of images 442, the associated complexity metrics, and the patient-specific data stored in the knowledge database 450.

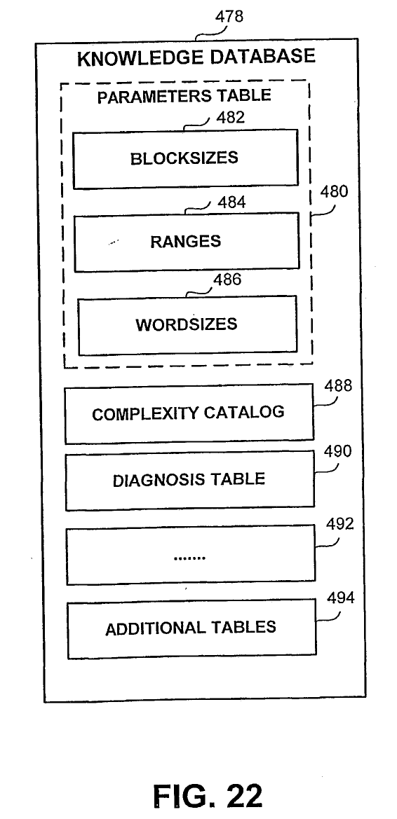

In the fifth preferred embodiment of the present invention the knowledge database provides vital data for the proper application of the complexity calculations and the final diagnosis. FIG. 22 shows the components constituting the knowledge database 478. The database 478 is a data structure implemented on a memory device such as a hard disk, a RAM device, a DRAM device, or an SDRAM device. The database 478 could be created and maintained using one of several known database management methods. The database 478 could be organized via known database organization methods such as hierarchical organization, or the like. The database 478 consists of a parameters table 480, a complexity catalog 488, a diagnosis table 490, and additional tables 492, 494. The parameters table 480 includes blocksizes 482, ranges 484, wordsizes 486, and the like. In addition the knowledge database 480 contains large tables of organs, diseases, and general information designed to assist in determining the optimal parameters for the complexity calculations and the diagnosis. For example, a liver with ×40 magnification of an alcoholic patient can have different range, blocksize, and wordsize parameters than a kidney of a diabetic patient at ×20 magnification. It would be easily understood that in other preferred embodiments of the invention additional tables containing additional information could be added to the database 480 such as a list of recommended treatments, and the like.

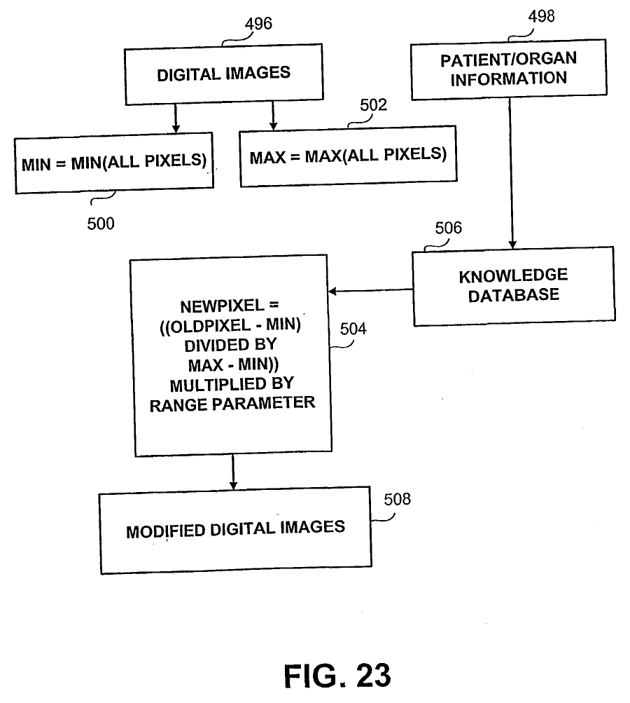

The digital images have a plurality of colors and different paintings have different resolutions. Thus, normalization of the digital images is necessary in order to accomplish a meaningful complexity value for the image blocks. FIG. 23 illustrates the procedure for the modification of the digital images. A digital image 496 is provided to the method and the values of the picture elements (pixels) constituting the image are calculated. The acceptable range parameter is read from the knowledge database 506. The range parameter is optionally customized by the patient/organ information 498. The entire set of pixels is processed and new pixel characteristics are assigned according to the following set of equations:

Min=MIN (all pixels)(500)

Max=MAX (all pixels)(502)

NewPixel=((Oldpixel−Min)/(Max−min))×Range(504)

The new pixels values or new pixel characteristics are utilized to construct the modified digital images 508 in which the range of differences across the set of pixels is substantially decreased.

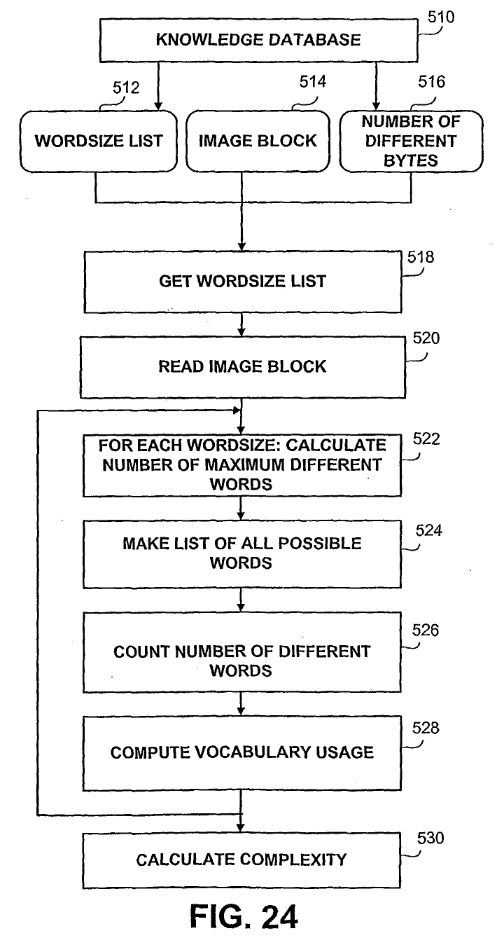

Referring now to FIG. 24 that illustrates the complexity calculation process. The procedure accesses the knowledge database 510 to obtain the parameter values regarding the wordsize list 512, and the range 516. The wordsize list 512 contains a list of integer pairs. The range parameters value 516 defines the number of different bytes for the processed image block 514. The image block 514 contains a two-dimensional array of RF1×RF2 pixel values. At step 518 the wordsize list 512 is read. At step 520 the image block 514 is obtained. At step 522 the program control initiates an execution loop across steps 522 through 528. The loop is executed for each wordsize element WS[1,2] (1 . . . k). At step 522 the number of maximum different words is calculated using the following equations:

Max2=(RF1−WS1(i)+1)×(RF2−WS2(i)+1)

Max2=Range to the [WS1(i)×WS2(i)]th power

MW=Min(Max1, Max2)

At step 524 a list of all possible words is created and at step 528 the number of different word is calculated by counting. At step 528 the value of the vocabulary usage (U) is computed using the equation:

U(i)=WN/MW

After handling the entire list of wordsizes the program control terminates the loop and the step 530 is performed in order to calculate the complexity value. The following equation is used:

Complexity=PRODUCT U(i) [i=from 1 to k]

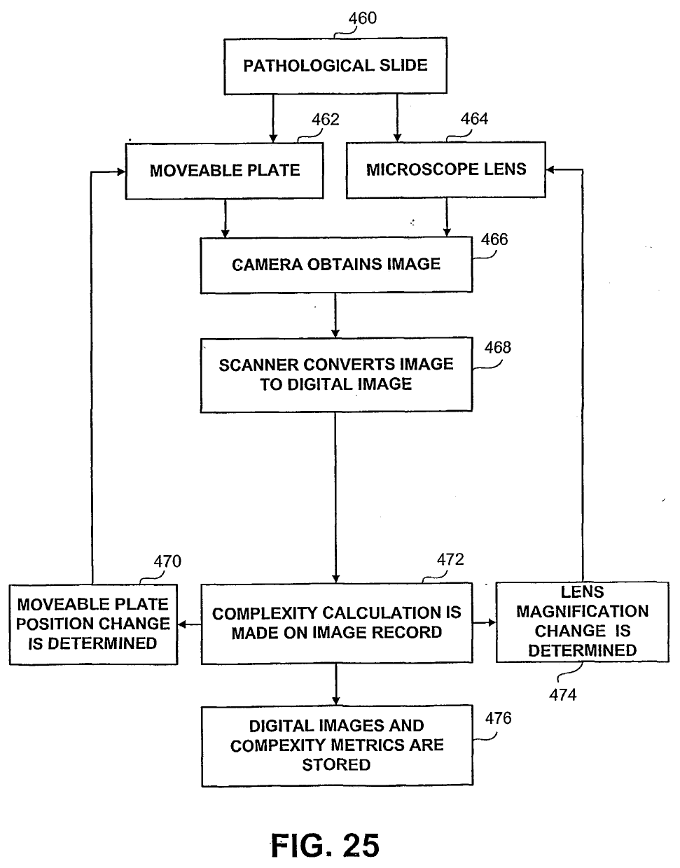

Turning now to FIG. 25 that illustrates the operation and the control of scanner device. A pathological slide 460 is placed on a moveable plate 462 having a specific orientation in regard to the slide 460. A camera takes an image 466 of the slide 460 through a microscopic lens 464 having a specific magnification factor. The scanner device processes the image taken by converting the analog image to a digital image 468. Complexity value calculations are made on the digital image 472 via the utilization of the complexity calculation procedure described hereinabove. The resulting complexity values could effect a lens magnification factor change 474, and a moveable plate position change 470. Thus, according to the complexity values the following images of the slide 460 could be affected such that areas having higher complexity will be more concentrated on.

Substantially simultaneously the digital images and the associated complexity metrics are suitably stored 476.

In several applications online processing of the data is of high importance. The proposed method and system provides an online version that enables substantially real-time processing of incoming information. The real-time processing includes all the above described operations such as the reception of the data records by the system, the division of the data records into blocks, the calculation of the complexity values of the blocks, the assignment of the complexity values to the blocks, and optionally the online production of the data summaries.

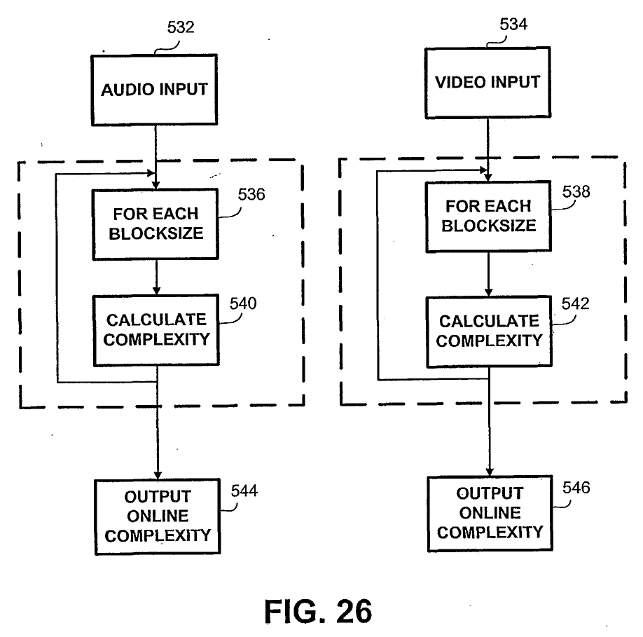

FIG. 26 is a highly simplified block diagram showing online creation of complexity catalogs. The system handles two inputs from different sources and in different formats. The audio input 532 is received by the method and for each blocksize 536 an online calculation of complexity is performed 540 affecting the output of the complexity file 544. The video input 534 is received by the system and for each blocksize 538 an online calculation of complexity is performed 542 affecting the output of a complexity file 546. Although on the drawing under discussion only a limited number of inputs are shown it would be easily understood by one with ordinary skills in the art that several input streams having differing formats could be handled substantially simultaneously online.

A series of useful applications to the basic embodiments of present invention can be applied will be described next. The second embodiment of the present invention can be applied to telephone tapping recorded output data, which is also a single-dimensional data stream. Presently, the setting of special filters for selecting words is used for the monitoring of known systems. These words must have special significance in the context of the circumstance. By using this monitoring procedure by setting special filters, such information as relative speaking times of the parties is not determinable, nor aspects such as loudness, voice inflections and the like. Through dividing recorded conversations into equal length segments and setting a metric threshold according to the most complex fragments, it is feasible to produce a meaningful summary of the monitoring data.

Similarly, the third embodiment of the present invention is utilizable in examining the multitude of data produced by radio astronomic evaluations of space. This field has a peculiar problem in that the universe consists of sparse data events. Any kind of useful filter that has no a priori basis would seem an advance to the progress of radio astronomy. In this case, a researcher would be able to look at interesting natural events and perhaps even interesting life form originated events. According to embodiments of the present invention, splicing the large amounts of data into like sized portions, allocating a complexity metric to each portion, the particular portions of highest metric and hence specific interest can be more closely investigated.

The third embodiment of the present invention can be applied to slicing a “film” data series into frame-sized fragments and assigning metrics to each fragment. Consequently, locating the most interesting of frames and clusters of frames above a predetermined metric threshold and deciding the extent of incorporating earlier or later proximate frames, allows the creation of short film clips. For example, this is achieved where the running average of complexity for a series of frames is above some threshold value. Compared to the prior art of editing a film data series by tediously examining a film data presentation virtually frame by frame, the procedure using embodiments of the present invention represents a simple and cost effective editing procedure. This procedure according to embodiments to the present invention is both innovative and an improvement to the art, when compared with that of the prior art.

A particular application of the application of the third embodiment is related to the preparation of film clips that can be used to facilitate the selling or hiring out of video films either on-line or even at specific retail outlets. Utilizing a collage of clips produced by a vendor from several similar category films, a potential customer is able to view, about fifteen-second clips from each movie, and consequently the selection of one or of his choices is facilitated.

To prepare a summarized video film clip from a video recording of a long sports event for screening merely significant highlights is another example of an application of the third preferred embodiment of the present invention. By slicing the video recording into like length sections, allocating a complexity metric to each section and collating the sections of highest metrics, it is possible to create a single, or even a series of highlights of the game. Highlights are frequently inserted into news broadcast presentations, where only an amount limited of time is available.

It is generally also necessary to include, with each high metric section, proximate sections to produce an element of continuity to each clip. For example, in a video film of an ice hockey game, the instant of a goal being scored, shown on a cluster of high metric sections of the video film, is not necessarily interesting. To allow the viewer to see at least, the moves leading to the goal and perhaps the team reaction after the goal, proximate sections are added to the high metric cluster.

Similarly there are many instances when prolonged nature studies produce enormously long video or audio records, in which only very small portions are of significance. A study of the mating habits of animals, behavioral rituals of species, the reaction of insect eating plants and the shedding of seeds by mechanical scattering are some examples of this type of study. Once again, in accordance with embodiments of the present invention, the film data is divided into equal length time fragments that are assigned complexity metrics. Using those of highest complexity and, perhaps, fragments proximate to these, details of aspects of significant interest are sorted from those of less or no interest.

The method and system suggested by the present invention is capable of processing two-dimensional data items, such as for compressing graphics, there is a well-known compression technique. This compression technique system utilizes, so-called, quad-trees. Using quad-trees, it is possible to recursively divide up a pixel map of the graphic into two-by-two areas, forming a block pixel with the average value of the original four-pixel group. Compressing two-dimensional graphics is achieved by applying the principles of the embodiments of the present invention. Using a quad-tree technique, determining quad-tree according to high complexity or some predetermined level of complexity thresholds and sorting data fragments according to pixel intensity, it is possible to create a montage of highlights of the graphic.

In terms of embodiments of the present invention, creating a montage of highlights of the graphic is accomplished by selecting elements of the highest intensity or of a particular intensity level. Selecting clusters of a series of elements varying from most to least interesting or most to intermediate level of interest, specific montages are created with items of interest superimposed one upon the next.

An additional example relates to the Internet: When a search engines searches for sites according to keywords, many sites are found. These sites are graded according to the complexity of the site itself. This means that the level of complexity is graded according to what is wanted. Thus, a simple summary of the subject at hand, of low complexity, or a more detailed account of a desired subject, of high complexity, is facilitated.

Multi-dimensional applications of the embodiments of the present invention could include the fields of geology, healthcare, cryptography, seismology, aerodynamics, reaction dynamics and almost every field of engineering.

I claim:

1. In a computing environment accommodating at least one input device connectable to at least one server device connectable to at least one output device, a method of processing at least one information unit introduced by the at least one input device by the at least one server device to create at least one information summary unit based on the at least one information unit, the method comprising the steps of:
creating at least one complexity catalog based on the at least one information unit; and
establishing at least one information summary unit based on the at least one complexity catalog.

2. The method of claim 1 further comprising the steps of:
obtaining at least one information unit from the at least one input device by the at least one server device; and
displaying the at least one information summary unit.

3. The method of claim 1 further comprising the steps of:
dynamically controlling the values operative in the establishment of the at least one complexity catalog; and
dynamically controlling the values operative in the establishment of the at least one information summary unit; and
selectively allocating resources for the processing of a sub-unit block in accordance with the complexity value assigned; and
comparing at least two information summary units; and
displaying the results of the comparison between the at least two information summary units.

4. The method of claim 1 wherein the step of creating the at least one complexity catalogs comprises the steps of:
partitioning the least one information unit into a pre-determined number of sub-unit blocks having a pre-determined size; and
assigning the pre-determined number of sub-unit blocks having a pre-determined size a complexity value according to a pre-determined complexity calculation.

5. The method of claim 1 wherein the step of establishing the at least one information summary unit comprises the steps of:
arranging the sub-unit blocks having a calculated complexity value into at least one ordered group of in accordance with the calculated complexity value of the participating sub-unit blocks; and
selecting at least one sub-group of the sub-unit blocks from the at least one ordered group of sub-unit blocks; and
building an information summary unit based on the selected at least one sub-group of the sub-unit blocks.

6. The method of claim 4 further comprising the steps of:
determining the number of the sub-unit blocks in accordance with the format of the at least one information unit; and
setting the size of the sub-unit blocks in accordance with the format of the at least one information unit; and
creating a list of word sizes concerning the content of the sub-unit blocks in accordance with the format of the at least one information unit; and
determining an optimally processable range of values constituting the sub-unit block in accordance with the format of the at least one information unit; and
normalizing the sub-unit block content values according to the pre-determined optimal range of values; and
computing the vocabulary usage value of the normalized sub-unit block; and
computing the complexity value of the normalized sub-unit block.

7. The method of claim 5 further comprising the steps of:
determining the size of the at least one information summary unit; and
determining the average number of characters in a word in accordance with the format of the at least one information unit.

8. The method of claim 2 further comprising the steps of:
reading the at least one information unit in text format in order to create at least one text information summary unit; and
obtaining the at least one information unit in audio format in order to create at least one audio information summary unit; and
receiving the at least one information unit in video format in order to create at least one video information summary unit; and
receiving the at least one information unit in image format in order to create at least one image information summary unit; and
acquiring the at least one information unit in data record format in order to create at least one data record information summary unit; and
getting the at least one information unit having combined formats in order to create a multi-format information summary unit.

9. The method of claim 1 wherein the method of processing at least one information unit is operative in a communication network.

10. In a computing environment accommodating at least one input device connected to at least one server device having at least one output device, a system for the processing at least one information unit introduced via the at least one input device by the at least one server device to create at least one information summary unit based on the at least one information unit, the system comprising the elements of:
an infrastructure server device to create at least one complexity catalog; and
a complexity catalog to hold at least one list of ordered complexity values associated with the partitioned sub-unit blocks; and
an application server to build at least one information summary unit based on the at least one information unit and on at least one associated complexity catalog.

11. The system of claim 11 further comprising the elements of:
a processor device to perform the instructions of the system software programs, and the application software programs; and
a communications device to support a functional communication path to remotely located input devices, remotely located output devices, remotely located storage devices, and remotely located processing devices; and
a storage device to hold the software programs operative in the running of the system and the associated methods; and
an operating system to supervise the operations of the software programs constituting the system and the associated method; and
an input database to store the at least one information unit introduced by the at least one input device.

12. The system of claim 10 wherein the infrastructure server comprises the elements of:
a set of control tables to store parameter values operative in the performance of the server; and
an input record handler to receive the at least one information unit, to store the at least one information unit, and to send the at least one information unit for processing; and
an information unit dividing component to partition the at least one information unit into sub-unit blocks; and
a complexity assignment component to calculate a complexity value for a sub-unit block; and
a complexity catalog handler component to update the at least one complexity catalog with the assigned complexity value of a sub-unit block.

13. The system of claim 10 wherein the application server comprises the elements of:
a complexity catalog handler to provide a functional interface between the complexity catalog and the processing components; and
an input database handler to provide a functional interface between the input database and the processing components; and
a resource allocation component to allocate resources in accordance with the differing complexity values of the sub-unit blocks in the complexity catalog; and
a summarizing component to establish the at least one information summary unit; and
a comparison component to compare among at least two information summary units; and
a user interface component to provide for communications between a human operator and the system.

14. The system of claim 10 wherein the infrastructure server consists of one or more computer-readable and computer-executable instruction sequences.

15. The system of claim 10 wherein the application server consists of one or more computer-readable and computer-executable instruction sequences.

16. The system of claim 10 wherein the complexity catalog is a data structure in a computer-readable format.

17. A pathology slide analysis system operative in the analysis of at least one pathology slide image taken of the cross-sections of body organs for the purpose of analysis and diagnosis, the system comprising the elements of:
a scanner device to scan selectively different portions of at least one pathology slide image and convert the resulting analog information into at least one digital image; and
a processor device to process the resulting at least one digital image containing the information received from the scanner and to control the input parameters of the system in order to locate and display the pathological portions of the at least one pathology slide.

18. The system of claim 17 further comprising the elements of:
a moving plate to provide for the placement of at least one pathology slide; and
a recorder device to record at least one image of at least one pathology slides; and
a magnifying device to controllably magnify at least one section of the pathology slid; and
a patient information file to provide additional data concerning at least one patient being checked via the processing of the at least one pathology slide; and
an output device to display pathological areas detected on the pathological slide.

19. The system of claim 18 wherein the processor device further comprising the elements of:
a knowledge base to store the parameter values operative in the processing of the at least one digital image representing information transformed from the analog representation of the pathology slide; and
an infrastructure server for partitioning the at least one digital image into sub-unit blocks, for calculating complexity values to the sub-unit blocks, and storing the complexity values into a complexity metrics catalog; and
an image analysis and control device to analyze the sub-unit blocks in association with the assigned complexity values and to adaptively modify the input parameters of the system.

20. The system of claim 19 wherein the knowledge database comprises the elements of:
a parameter table to hold the parameter values operative in the partitioning of the at least one digital image, and in the assignment of the complexity values to the sub-unit blocks; and
a diagnosis table to hold results of the analysis; and
a complexity catalog to store the complexity values assigned to the sub-unit blocks constituting the at least one digital image.

21. The system of claim 20 wherein the parameter table comprises the elements of:
a pre-determined sub-unit block size value; and
a pre-determined optimal image content value range value; and
a list of potential word sizes concerning the content of the at least one digital image.

22. A pathology slide analysis method for the analysis of at least one pathology slide image taken of the cross-sections of body organs for the purpose of analysis and diagnosis, the method comprising the steps of:
normalizing the at least one digital image by the content value range of the image to an optimally processable value range in accordance with the range parameters value in the knowledge database; and
partitioning the at least one digital image into a pre-determined number of sub-unit blocks having a pre-determined and equal size; and
calculating the complexity value of the sub-unit blocks in accordance with pre-defined parameter values and utilizing a pre-determined sequence of calculation steps; and
establishing a complexity metrics catalog to hold the complexity values associated with the sub-unit blocks constituting the at least one digital image; and
analyzing the content of the digital images in association with the complexity values assigned to the sub-unit blocks constituting the digital image; and
adaptively modifying the spatial coordinates of the moveable plate in order to expose different portions of the pathology slide to the recording device; and
adaptively modifying the magnification factor of the magnifying lens in order to facilitate selective concentration on the relevant portions of the pathology slide.

23. The method of claim 22 further comprising the steps of:
obtaining at least one digital image of at least one pathology slide; and
performing diagnosis of the examined patient in accordance with the result of the analysis; and
displaying the results of the analysis.

24. The system of claim 18 wherein the patient information file is a data structure designed in a computer-readable format.

25. The system of claim 19 wherein the knowledge base is a data structure designed in a computer-readable format.

26. The system of claim 19 wherein the infrastructure server is one or more computer-readable and computer-executable instruction sequences.

27. The system of claim 19 wherein the application server is one or more computer-readable and computer-executable instruction sequences.
